(19) United States
(12) Patent Application Publication
(10) Pub. No.: US 2022/0277323 A1
(43) Pub. Date: Sep. 1, 2022

(54) PREDICTING FUTURE OCCURRENCES OF TARGETED EVENTS USING TRAINED ARTIFICIAL-INTELLIGENCE PROCESSES

(71) Applicant: The Toronto-Dominion Bank, Toronto (CA)

(72) Inventors: Patrick James WHELAN, Oakville (CA); Jahir Mauricio GUTIERREZ BUGARIN, Toronto (CA); Nikki KANADE, Toronto (CA); Maksims VOLKOVS, Toronto (CA); Tomi Johan POUTANEN, Toronto (CA)

(21) Appl. No.: 17/681,215

(22) Filed: Feb. 25, 2022

Related U.S. Application Data
(60) Provisional application No. 63/154,796, filed on Feb. 28, 2021.

(51) Int. Cl. G06Q 30/02

(52) U.S. Cl. CPC G06Q 30/0201

(57) ABSTRACT

The disclosed embodiments include computer-implemented apparatuses and processes that dynamically predict future occurrences of targeted events using adaptively trained machine-learning or artificial-intelligence processes. For example, an apparatus may generate an input dataset based on interaction data associated with a prior temporal interval, and may apply a trained, gradient-boosted, decision-tree process to the input dataset. Based on the application of the trained, gradient-boosted, decision-tree process to the input dataset, the apparatus may generate output data representative of a predicted likelihood of an occurrence of each of a plurality of targeted events during a future temporal interval, which may be separated from the prior temporal interval by a corresponding buffer interval. The apparatus may also transmit the output data to a computing system, and the computing system may transmit digital content to a device based on at least a portion of the output data.

### CROSS-REFERENCE TO RELATED APPLICATION

This application claims the benefit of priority under 35 U.S.C. § 119(e) to prior U.S. Provisional Application No. 63/154,796, filed Feb. 28, 2021, the disclosure of which is incorporated by reference herein to its entirety.

### TECHNICAL FIELD

The disclosed embodiments generally relate to computer-implemented systems and processes that facilitate a prediction of future occurrences of targeted events using trained artificial intelligence processes.

### BACKGROUND

Today, financial institutions offer a variety of financial products or services to their customers, both through in-person branch banking and through various digital channels, and these financial institutions often obtain, generate, or maintain elements of data identifying and characterizing the customers, one or more financial products issued to the customers, one or more transactions involving these issued financial products, and the customers' interactions with the financial institutions through in-person or digital communications channels. Further, decisions related to the provisioning of a particular financial product or service to a customer are often informed by the customer's relationship with the financial institution and the customer's use, or misuse, of other financial products or services, and are based on information provisioned during completion of a product- or service-specific application process by the customers.

### SUMMARY

In some examples, an apparatus includes a memory storing instructions, a communications interface, and at least one processor coupled to the memory and the communications interface. The at least one processor is configured to execute the instructions to generate an input dataset based on elements of first interaction data associated with a first temporal interval, and based on an application of a trained artificial intelligence process to the input dataset, to generate output data indicative of a predicted likelihood of an occurrence of each of a plurality of targeted events during a second temporal interval. The second temporal interval is subsequent to the first temporal interval and is separated from the first temporal interval by a corresponding buffer interval. The at least one processor is further configured to execute the instructions to transmit the output data to a computing system via the communications interface. The computing system is configured to transmit digital content to a device based on at least a portion of the output data.

In other examples, a computer-implemented method includes generating, using at least one processor, an input dataset based on elements of first interaction data associated with a first temporal interval, and based on an application of a trained artificial intelligence process to the input dataset, generating, using the at least one processor, output data indicative of a predicted likelihood of an occurrence of each of a plurality of targeted events during a second temporal interval. The second temporal interval is subsequent to the first temporal interval and is separated from the first temporal interval by a corresponding buffer interval. The computer-implemented method also includes transmitting the output data to a computing system using the at least one processor. The computing system is configured to transmit digital content to a device based on at least a portion of the output data.

Further, in some examples, a tangible, non-transitory computer-readable medium storing instructions that, when executed by at least one processor, cause the at least one processor to perform a method that includes generating an input dataset based on elements of first interaction data associated with a first temporal interval. Based on an application of a trained artificial intelligence process to the input dataset, the method generates output data indicative of a predicted likelihood of an occurrence of each of a plurality of targeted events during a second temporal interval. The second temporal interval is subsequent to the first temporal interval and is separated from the first temporal interval by a corresponding buffer interval. The method also includes transmitting the output data to a computing system. The computing system is configured to transmit digital content to a device based on at least a portion of the output data.

It is to be understood that both the foregoing general description and the following detailed description are exemplary and explanatory only and are not restrictive of the invention, as claimed. Further, the accompanying drawings, which are incorporated in and constitute a part of this specification, illustrate aspects of the present disclosure and together with the description, serve to explain principles of the disclosed exemplary embodiments, as set forth in the accompanying claims.

### BRIEF DESCRIPTION OF THE DRAWINGS

FIGS. 1A and 1B are block diagrams illustrating portions of an exemplary computing environment, in accordance with some exemplary embodiments.

FIGS. 1C and 1D are diagrams of exemplary timelines for adaptively training a machine-learning or artificial intelligence process, in accordance with some exemplary embodiments.

FIGS. 2A and 2B are block diagrams illustrating additional portions of the exemplary computing environment, in accordance with some exemplary embodiments.

FIG. 3 is a flowchart of an exemplary process for adaptively training a machine learning or artificial intelligence process, in accordance with some exemplary embodiments.

FIG. 4 is a flowchart of an exemplary process for predicting a likelihood of an occurrence of each of a plurality of predetermined, targeted acquisition events involving a customer of the financial institution during a future temporal interval using adaptively trained machine-learning or artificial-intelligence processes, in accordance with some exemplary embodiments.

Like reference numbers and designations in the various drawings indicate like elements.

### DETAILED DESCRIPTION

Modern financial institutions offer a variety of financial products or services to their customers, both through in-person branch banking and through various digital channels, and decisions related to the provisioning of a particular financial product or service to a customer are often informed by the customer's relationship with the financial institution and the customer's use, or misuse, of other financial products or services. For example, one or more computing systems of a financial institution may obtain, generate, and maintain elements of customer profile data identifying the customer and characterizing the customer's relationship with the financial institution, account data identifying and characterizing one or more financial products issued to the customer by the financial institution, transaction data identifying and characterizing one or more transactions involving these issued financial products, or access data characterizing the customer's interactions with the financial institution through in-person or digital communications channels. The elements of customer profile data, account data, transaction data, and/or access data may establish collectively a time-evolving risk profile for the customer, and the financial institution may base not only a decision to provision the particular financial product or service to the customer, but also a determination of one or more initial terms and conditions of the provisioned financial product or service, on the established risk profile.

By way of example, the one or more financial products may include a deposit account, such as a checking account, issued to a particular customer by the financial institution (e.g., a “primary” checking account), and the primary checking account may hold funds denominated in one or more currencies, such as, but not limited to, U.S. or Canadian dollars. In many instances, and subsequent to the issuance of the primary checking account, the particular customer may apply for, and the financial institution may issue, one or more additional checking accounts (e.g., “secondary” checking accounts), which may hold funds denominated in a currency consistent with the primary checking account, or in a currency different from that of the primary checking account. The reasons that drive the particular customer to obtain the one or more secondary checking accounts may include, but are not limited to, an intention of the particular customer to share of household expenses, a desire of the particular customer to enhance a financial literacy or independence of a family members, a need to manage incoming streams of funds from various sources, or a need to submit regular payments for goods or services, such as expenses related to a college education of a dependent.

While the one or more computing systems of the financial institution may perform operations that analyze the maintained elements of customer profile, account, transaction, or access data associated with the customers of the financial institution during a current temporal interval, and apply one or more rules-based processes to selected portions of the maintained elements of customer profile, account, transaction, or access data, these rules-based analytical operations often rely on values of coarse metrics that characterize a customer or the customer's behavior and current interaction with the financial institution, and often fail to detect, or analyze, subtle changes in the customer's saving, spending, or purchasing habits, or in the customer's interactions with the financial institution through in-person or digital communications channels, which may signal an unrecognized need on the part of the particular customer for the one or more secondary checking accounts. Further, although adaptive techniques may exist to identify customers of the financial institution that are likely to acquire certain financial products during a current temporal interval, these adaptive techniques are often incapable of characterizing a propensity of a customer that holds a primary financial product, such as a primary checking account, to acquire an additional one of the financial products, such as a secondary checking account, during a future temporal interval.

In some examples, described herein, the one or more computing systems of the financial institution may perform operations that train adaptively a machine-learning or artificial-intelligence process to predict a likelihood of an occurrence of each of a plurality of predetermined, targeted acquisition events involving a customer of the financial institution during a future temporal interval using training datasets associated with a first prior temporal interval (e.g., a “training” interval), and using validation datasets associated with a second, and distinct, prior temporal interval (e.g., an out-of-time “validation” interval). As described herein, the machine-learning or artificial-intelligence process may include an ensemble or decision-tree process, such as a gradient-boosted decision-tree process (e.g., the XGBoost process), and the training and validation datasets may include, but are not limited to, values of adaptively selected features obtained, extracted, or derived from the maintained elements of customer profile, account, transaction, or access data associated with the customers of the financial institution, the customer's interactions with various financial products, and the customer's interactions with the financial institution through in-person or digital communications channels.

By way of example, the customer of the financial institution may hold a checking account issued by the financial institution (e.g., a “primary” checking account) which may hold funds denominated a corresponding currency, such as Canadian or U.S. dollars, and the plurality of predetermined, targeted acquisition events may include, but are not limited to, a first targeted acquisition event associated with an acquisition, by the customer, of an additional checking account issued by the financial institution and (e.g., a “secondary” checking account) holding funds denominated in a first currency (e.g., Canadian dollars), a second targeted acquisition event associated with an acquisition, by the customer, of a secondary checking account issued by the financial institution and holdings funds denominated in a second currency (e.g., U.S. dollars), and a third targeted acquisition event associated with a failure of the customer to acquire a secondary checking account issued by the financial institution. As described herein, the customer of the financial institution may “acquire” a secondary checking account upon a successful completion of a corresponding application or underwriting process performed or implemented by the financial institution.

In some instances, and through an implementation of one or more of the exemplary processes described herein, the one or more computing systems of the financial institution may train, adaptively and simultaneously, a gradient-boosted decision-tree process (e.g., the XGBoost process) to predict, at a corresponding temporal prediction point, (i) a likelihood of an occurrence of the first targeted acquisition event involving the customer during the future temporal interval (e.g., the acquisition of the secondary checking account holding funds denominated in the first currency), (ii) a likelihood of an occurrence of the second targeted acquisition event involving the customer during the future temporal interval (e.g., the acquisition of the secondary checking account holding funds denominated in the second currency), and (iii) a likelihood of an occurrence of the third targeted acquisition event involving the customer during the future temporal interval (e.g., the failure to acquire the secondary checking account) using the training datasets associated with the training interval, and using the validation datasets associated with validation interval. For example, one or more computing systems of the financial institution may include one or more distributed computing components, which may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes.

Further, upon application of the trained gradient-boosted, decision-tree process to an input dataset associated with the customer of the financial institution, the one or more computing systems of the financial institution may perform operations described herein, to generate elements to output data that include, among other things, a numerical value indicative of the predicted likelihood of the occurrence of each of the first targeted acquisition event, the second targeted acquisition event, or the third targeted acquisition event involving the customer during the future temporal interval. In some examples, each of the numerical values may range from zero to unity, and the numerical values characterizing the predicted likelihoods of the occurrences of the first, second, and third targeted acquisition events involving the customer (e.g., that holds the primary checking account) during the future temporal interval may sum to unity.

Certain of these exemplary processes, which adaptively train and validate a gradient-boosted, decision-tree process using customer-specific training and validation datasets associated with respective training and validation periods, and which apply the trained and validated gradient-boosted, decision-tree process to additional customer-specific input datasets, may enable the one or more of the FI computing systems to predict, in real-time, a likelihood of an occurrence a plurality of predetermined, targeted acquisition events involving a customer that holds a primary financial product (such as, but not limited to, a primary checking account) and one or more secondary financial products (such as, but not limited to, one or more secondary checking accounts), during a predetermined, future temporal interval. These exemplary processes may be implemented in addition to, or as alternative to, one or more rules-based analytical processes through which the one or more computing systems of the financial institution analyze maintained elements of customer profile, account, transaction, or access data associated with the customers of the financial institution, and identify one or more of the customers that represent candidate applicants for financial products offered by the financial institution during a current temporal interval.

### A. Exemplary Processes for Adaptively Training Gradient-Boosted, Decision-Tree Processes in a Distributed Computing Environment

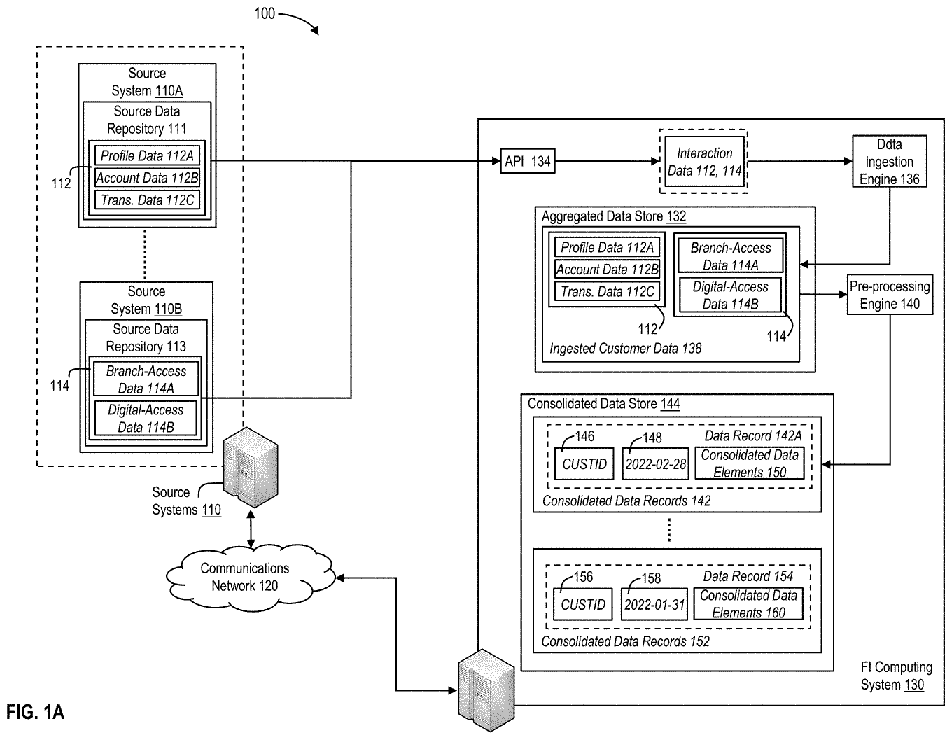

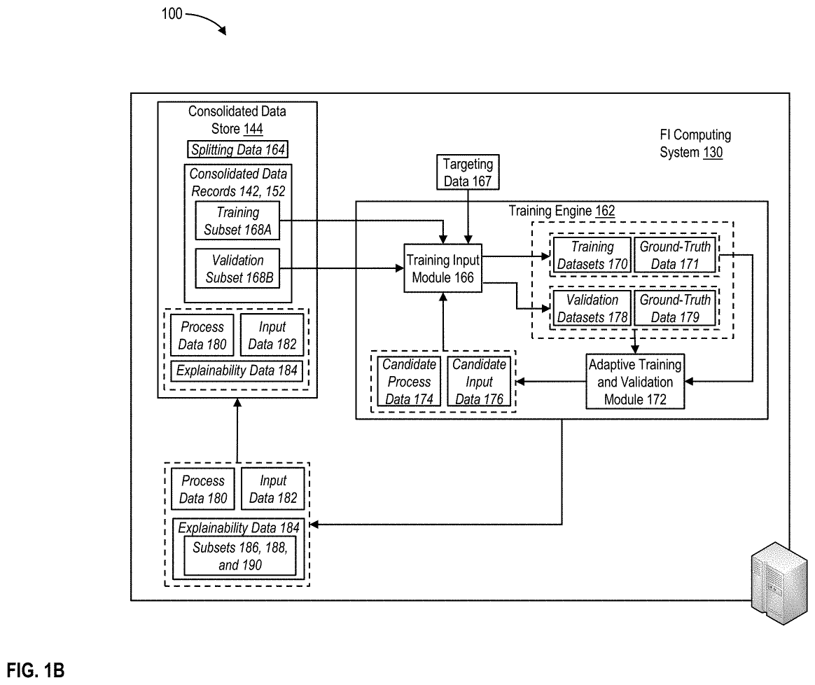

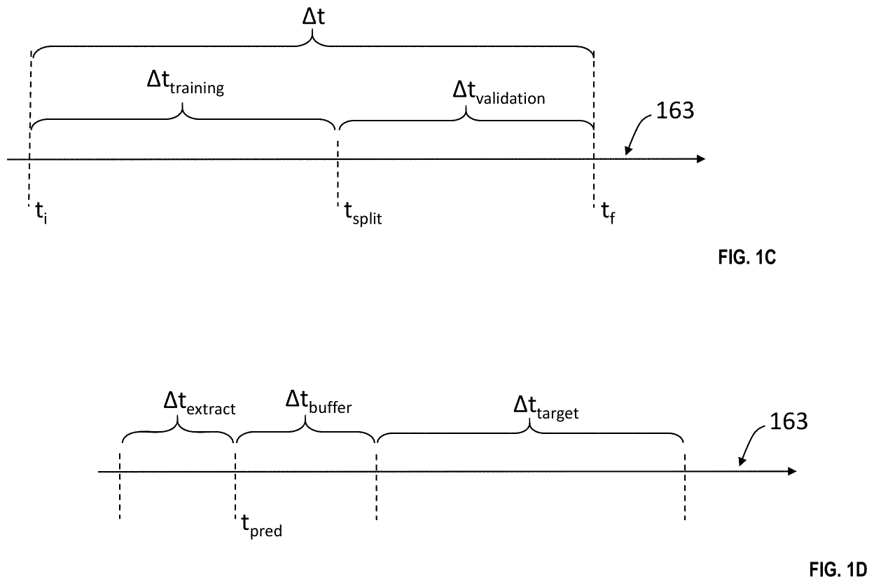

FIGS. 1A and 1B illustrate components of an exemplary computing environment 100, in accordance with some exemplary embodiments. For example, as illustrated in FIG. 1A, environment 100 may include one or more source systems 110, such as, but not limited to, source systems 110A and 110B, and a computing system associated with, or operated by, a financial institution, such as financial institution (FI) computing system 130. In some instances, each of source systems 110 (including source system 110A and source system 110B), and FI computing system 130 may be interconnected through one or more communications networks, such as communications network 120. Examples of communications network 120 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet.

In some examples, each of source systems 110 (including source systems 110A and 110B) and FI computing system 130 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of source systems 110 (including source systems 110A and 110B) and FI computing system 130 may also include a communications interface, such as one or more wireless transceivers, coupled to the one or more processors for accommodating wired or wireless internet communication with other computing systems and devices operating within environment 100.

Further, in some instances, source systems 110 (including source systems 110A and 110B) and FI computing system 130 may each be incorporated into a respective, discrete computing system. In additional, or alternate, instances, one or more of source systems 110 (including source system 110A and source system 110B) and FI computing system 130 may correspond to a distributed computing system having a plurality of interconnected, computing components distributed across an appropriate computing network, such as communications network 120 of FIG. 1A. For example, FI computing system 130 may correspond to a distributed or cloud-based computing cluster associated with, and maintained by, the financial institution, although in other examples, FI computing system 130 may correspond to a publicly accessible, distributed or cloud-based computing cluster, such as a computing cluster maintained by Microsoft Azure™ Amazon Web Services™, Google Cloud™, or another third-party provider.

In some instances, FI computing system 130 may include a plurality of interconnected, distributed computing components, such as those described herein (not illustrated in FIG. 1A), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of FI computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle. Through an implementation of the parallelized, fault-tolerant distributed computing and analytical protocols described herein, the distributed computing components of FI computing system 130 may perform any of the exemplary processes described herein, to ingest elements of data associated with the customers of the financial institution and acquisition events involving these customers, to preprocess the ingested data elements by filtering, aggregating, or downsampling certain portions of the ingested data elements, and to store the preprocessed data elements within an accessible data repository (e.g., within a portion of a distributed file system, such as a Hadoop distributed file system (HDFS)).

Further, and through an implementation of the parallelized, fault-tolerant distributed computing and analytical protocols described herein, the distributed components of FI computing system 130 may perform operations in parallel that not only train adaptively a machine learning or artificial intelligence process (e.g., the gradient-boosted, decision-tree process described herein) using corresponding training and validation datasets extracted from temporally distinct subsets of the preprocessed data elements, but also apply the adaptively trained machine learning or artificial intelligence process to customer-specific input datasets and generate, in real time, elements of output data indicative of a likelihood of an occurrence of each of a plurality of predetermined, targeted acquisition events involving corresponding ones of the customer during the future temporal interval, such a one-month interval between one and two months from a prediction date. The implementation of the parallelized, fault-tolerant distributed computing and analytical protocols described herein across the one or more GPUs or TPUs included within the distributed components of FI computing system 130 may, in some instances, accelerate the training, and the post-training deployment, of the machine-learning and artificial-intelligence process when compared to a training and deployment of the machine-learning and artificial-intelligence process across comparable clusters of CPUs capable of processing a single operation per clock cycle.

Referring back to FIG. 1A, each of source systems 110 may maintain, within corresponding tangible, non-transitory memories, a data repository that includes confidential data associated with the customers of the financial institution. For example, source system 110A may be associated with, or operated by, the financial institution, and may maintain, within the corresponding one or more tangible, non-transitory memories, a source data repository 111 that includes elements of interaction data 112. In some instances, interaction data 112 may include data that identifies or characterizes one or more customers of the financial institution and interactions between these customers and the financial institution, and examples of the confidential data include, but are not limited to, customer profile data 112A, account data 112B, and/or transaction data 112C.

In some instances, customer profile data 112A may include data records associated with, and characterizing, corresponding ones of the customers of the financial institution. By way of example, and for a particular customer of the financial institution, the data records of customer profile data 112A may include, but are not limited to, one or more unique customer identifiers (e.g., an alphanumeric character string, such as a login credential, a customer name, etc.), residence data (e.g., a street address, a city or town of residence, etc.), other elements of contact data (e.g., a mobile number, an email address, etc.), values of demographic parameters that characterize the particular customer (e.g., ages, occupations, marital status, etc.), and other data characterizing the relationship between the particular customer and the financial institution (e.g., a customer tenure at the financial institution, etc.). Further, customer profile data 112A may also include, for the particular customer, data records that include corresponding elements of temporal data (e.g., a time or date stamp, etc.), and the data records may establish, for the particular customer, a temporal evolution in the customer residence or a temporal evolution in one or more of the demographic parameter values.

Account data 112B may include data records that identify and characterize one or more financial products or financial instruments issued by the financial institution to corresponding ones of the customers, and transaction data 112C may include a plurality of data records that identify, and characterize one or more initiated, settled, or cleared transactions involving respective ones of the customers and corresponding ones of the issued financial products. Examples of these financial products may include, but are not limited to, one or more deposit accounts issued to corresponding ones of the customers (e.g., a savings account, a checking account, etc.), one or more brokerage or retirements accounts issued to corresponding ones of the customers by the financial institutions, and one or more secured credit products issued to corresponding ones of the customers by the financial institution. Further, examples of the initiated, settled, or cleared transactions involving these financial products may include, but are not limited to, purchase transactions, bill-payment transactions, electronic funds transfers, currency conversions, purchases of securities, derivatives, or other tradeable instruments, withdrawals of funds from automated teller machines (ATMs), electronic funds transfer (EFT) transactions, peer-to-peer (P2P) transfers or transactions, or real-time payment (RTP) transactions.

The data records of account data 112B may include, for each of the financial products issued to corresponding ones of the customers, one or more identifiers of the financial product (e.g., an account number, expiration data, card-security-code, etc.), a corresponding product identifier (e.g., an alphanumeric product identifier associated with the financial product, etc.), one or more unique customer identifiers (e.g., an alphanumeric character string, such as a login credential, a customer name, etc.), and additional information characterizing a balance or current status of the financial product or instrument (e.g., payment due dates or amounts, delinquent accounts statuses, etc.). In some instances, for certain of the financial products, such as, but not limited to, a checking account held by a corresponding one of the customers, the data records of account data 112B may also include temporal data specifying a date on which the financial institution issued the checking account to the corresponding one of the customers and data characterizing a national currency associated with the checking account (e.g., U.S. dollars, Canadian dollars, etc.). Further, and for a particular transaction involving a corresponding customer and corresponding one of the financial products, the data records of transaction data 112C may include, but are limited to, a customer identifier of the corresponding customer (e.g., the alphanumeric character string described herein, etc.), a counterparty identifier associated with a counterparty to the particular transaction (e.g., an alphanumeric character string, a counterparty name, etc.), an identifier of the corresponding financial product (e.g., a tokenized account number, expiration data, card-security-code, etc.), and values of one or more parameters of the particular transaction (e.g., a transaction amount, a transaction date, etc.).

In some instances, the data records of account data 112B may also include, for one or more customers of the financial institution, a value of one or more aggregated account parameters that characterize an interaction between these customers and corresponding ones of the financial products across one or more prior temporal intervals (e.g., a prior month, a prior six-month period, a prior calendar year, etc.). By way of example, and for a particular customer of the financial institution, the data records of account data 112B may associate a unique customer identifier of the particular customer with, among other things, an average monthly balance of a financial product held by the particular customer or an average monthly flow of cash into, or from, a savings account, checking account, or other deposit account held by the particular customer.

Further, the data records of transaction data 112C may also include, for one or more customers of the financial institution, a value of one or more aggregated transaction parameters that characterize the initiated, settled, or cleared transactions across one or more prior temporal intervals (e.g., a prior month, a prior six-month period, a prior calendar year, etc.). By way of example, and for a particular customer of the financial institution, the data records of transaction data 112C may associate a unique customer identifier with, among other things, data characterizing an average monthly spend by the particular customer on predetermined goods or services (e.g., associated with corresponding universal product codes (UPCs)), involving predetermined financial products (e.g., associated with corresponding product identifiers), predetermined merchants or retailers, and/or involving predetermined classes of merchants or retailers (e.g., associated with corresponding Standard Industrial Classification (SIC) codes or Merchant Classification Codes (MCCs)). In other examples, the data records of transaction data 112C may, for the particular customer, also associate the unique customer identifier with an aggregate number of transactions involving an ATMs across the one or more temporal intervals, an average amount of funds withdrawn from a corresponding financial account (e.g., a checking account, etc.) through the ATMs during the one or more prior temporal intervals (e.g., on a daily basis, a monthly basis, etc.), and additionally, or alternatively, currencies into which corresponding portions of the withdrawn funds are denominated (e.g., U.S. dollars, Canadian dollars, etc.).

The disclosed embodiments are, however, not limited to these exemplary elements of customer profile data 112A, account data 112B, or transaction data 112C. In other instances, the data records of interaction data 112 may include any additional or alternate elements of data that identify and characterize the customers of the financial institution and their relationships or interactions with the financial institution, financial products issued to these customers by the financial institution, and transactions involving corresponding ones of the customers and the issued financial products. Further, although stored in FIG. 1A within data repositories maintained by source system 110A, the exemplary elements of customer profile data 112A, account data 112B, and transaction data 112C may be maintained by any additional or alternate computing system associated with the financial institution, including, but not limited to, within one or more tangible, non-transitory memories of FI computing system 130.

Source system 110B may also be associated with, or operated by, the financial institution, and may maintain, within the corresponding one or more tangible, non-transitory memories, a source data repository 113 that includes one or more elements of interaction data 114 that identify, and characterize, one or more discrete interactions between customers of the financial institution and one or more retail locations (e.g., bank branches) of the financial institution in corresponding geographic regions and additionally, or alternatively, one or more voice-based or digital platforms maintained by the financial institution (e.g., call centers, web-based platforms, app-based platforms, etc.). By way of example, interaction data 114 may include branch-access data 114A, which includes data records that identify and characterize discrete interactions between customers of the financial institution and corresponding bank branches of the financial institution and further, one or more transactions initiated by these customers during these discrete interactions (e.g., deposits or withdrawals of funds, bill payment transactions, etc.). For instance, and for an interaction of a particular customer of the financial institution with a corresponding bank branch, the data records of branch-access data 114A may include a unique customer identifier of the customer (e.g., the alphanumeric character string described herein, etc.), with a unique identifier of the corresponding bank branch (e.g., an alphanumeric branch identifier assigned to the corresponding bank branch by the financial institution, etc.), temporal data characterizing a time or date of the interaction, and data characterizing one or more discrete transactions initiated by the particular customer during the interaction, such as, but not limited to, a transaction type (e.g., deposit, withdrawal, etc.), a transaction amount, and a currency associated with the transaction amount.

The data records of branch-access data 114A may also include, for one or more customers of the financial institution, an aggregate value of one or more parameters that characterize an interaction between these customers and corresponding ones of the bank branches across one or more prior temporal intervals (e.g., a prior month, a prior six-month period, a prior calendar year, etc.). By way of example, and for the particular customer, the data records of branch-access data 114A may associate the unique customer identifier of the particular customer with, among other things, a total number of discrete visits to a corresponding bank branch (e.g., associated with unique, alphanumeric branch identifier, as described herein) during one or more of the prior temporal intervals, a total number of one or more transaction types initiated during visits to a corresponding bank branch during one or more of the prior temporal intervals (a total number of initiated withdrawals, a total number of initiated deposits, etc.), an average transaction amount associated with transaction types initiated at a corresponding one of the bank branches during one or more of the prior temporal intervals (e.g., an average value of initiated withdrawal, deposit, or bill-payment transactions denominated in Canadian, U.S., or other currencies, etc.), and/or a range of transaction amounts associated with these initiated transactions (e.g., a maximum and a minimum, etc.).

Further, in other examples, interaction data 114 may also include digital-access data 114B, which includes data records that identify and characterize discrete interactions between customers of the financial institution and corresponding voice-based or digital platforms of the financial institution during one or more prior temporal intervals. As described herein, the voice-based platforms may include, among other things, a call center maintained by the financial institution or by a third-party, and the digital platforms ma include, among other things, a web-based platform associated with a corresponding web page of the financial institution and a app-based platform associated with a corresponding mobile application of the financial institution. By way of example, and for an interaction of a particular customer of the financial institution with a corresponding voice-based or digital platform branch, the data records of digital-access data 114B may include a unique customer identifier of the customer (e.g., the alphanumeric character string described herein, etc.), a unique identifier of the corresponding voice-based or digital platform (e.g., an alphanumeric platform identifier assigned to the corresponding voice-based or digital platform branch, a platform type, etc.), temporal data characterizing a time or date of the interaction, and in some instances, data characterizing one or more discrete transactions initiated by the particular customer during the interaction, such as, but not limited to, a transaction type (e.g., deposit, withdrawal, etc.), a transaction amount, and a currency associated with the transaction amount.

The data records of digital-access data 114B may also include, for one or more customers of the financial institution, an aggregate value of one or more parameters that characterize an interaction between these customers and corresponding ones of the voice-based or digital platforms across one or more prior temporal intervals (e.g., a prior month, a prior six-month period, a prior calendar year, etc.). By way of example, and for the particular customer, the data records of digital-access data 114B may associate the unique customer identifier of the particular customer with, among other things, a total number of discrete interactions with a corresponding one of the voice-based or digital platforms (e.g., as associated with a corresponding alphanumeric platform identifier or platform type, as described herein) during one or more of the prior temporal intervals, a total number of one or more transaction types initiated during these interactions (a total number of initiated withdrawals, a total number of initiated deposits, etc.), an average transaction amount associated with transaction types initiated at via the corresponding voice-based or digital platform during one or more of the prior temporal intervals (e.g., an average value of initiated withdrawal, deposit, or bill-payment transactions denominated in Canadian, U.S., or other currencies, etc.), and/or a range of transaction amounts associated with these initiated transactions (e.g., a maximum and a minimum, etc.).

The disclosed embodiments are, however, not limited to these exemplary elements of branch-access data 114A or digital-access data 114B. In other instances, the data records of interaction data 114 may include any additional or alternate elements of data that identify and characterize the customers of the financial institution and their interactions with the bank branches of the financial institution, or with the voice-based or digital platforms maintained by the financial institution and one or more transactions initiated during these interactions corresponding ones of the customers and the issued financial products, e.g., on a discrete or aggregated basis. Further, although stored in FIG. 1A within data repositories maintained by source system 110B, the exemplary elements of branch-access data 114A or digital-access data 114B may be maintained by any additional or alternate computing system associated with the financial institution, including, but not limited to, within one or more tangible, non-transitory memories of FI computing system 130.

In some instances, FI computing system 130 may perform operations that establish and maintain one or more centralized data repositories within a corresponding ones of the tangible, non-transitory memories. For example, as illustrated in FIG. 1A, FI computing system 130 may establish an aggregated data store 132, which maintains, among other things, elements of the customer profile, account, transaction, credit-bureau data, and acquisition data associated with one or more of the customers of the financial institution, which may be ingested by FI computing system 130 (e.g., from one or more of source systems 110) using any of the exemplary processes described herein. Aggregated data store 132 may, for instance, correspond to a data lake, a data warehouse, or another centralized repository established and maintained, respectively, by the distributed components of FI computing system 130, e.g., through a Hadoop™ distributed file system (HDFS).

For example, FI computing system 130 may execute one or more application programs, elements of code, or code modules that, in conjunction with the corresponding communications interface, establish a secure, programmatic channel of communication with each of source systems 110, including source system 110A and source system 110B, across network 120, and may perform operations that access and obtain all, or a selected portion, of the elements of customer profile, account, transaction, credit-bureau, and/or acquisition data maintained by corresponding ones of source systems 110. As illustrated in FIG. 1A, source system 110A may perform operations that obtain all, or a selected portion, of interaction data 112, including the data records of customer profile data 112A, account data 112B, and transaction data 112C, from source data repository 111, and transmit the obtained portions of interaction data 112 across network 120 to FI computing system 130. Further, source system 110B may perform operations that obtain all, or a selected portion, of interaction data 114, including the data records of branch-access data 114A and digital-access data 114B, from source data repository 113, and transmit the obtained portions of interaction data 114 across network 120 to FI computing system 130.

In some instances, and prior to transmission across network 120 to FI computing system 130, source system 110A and source system 1106 may encrypt respective portions of interaction data 112 (including the data records of customer profile data 112A, account data 1126, and transaction data 112C), and interaction data 114 (including the data records of data records of branch-access data 114A and digital-access data 114B) using a corresponding encryption key, such as, but not limited to, a corresponding public cryptographic key associated with FI computing system 130. Further, although not illustrated in FIG. 1A, each additional, or alternate, one of source systems 110 may perform any of the exemplary processes described herein to obtain, encrypt, and transmit additional, or alternate, portions of the customer profile, account, transaction, branch-access, and/or digital-access data maintained locally maintained by source systems 110 across network 120 to FI computing system 130.

A programmatic interface established and maintained by FI computing system 130, such as application programming interface (API) 134, may receive the portions of interaction data 112 (including the data records of customer profile data 112A, account data 1126, and transaction data 112C) from source system 110A and the portions of interaction data 114 (including the data records of branch-access data 114A and digital-access data 114B) from source system 1106. As illustrated in FIG. 1A, API 134 may route the portions of interaction data 112 (including the data records of customer profile data 112A, account data 112B, and transaction data 112C) and interaction data 114 (including the data records of branch-access data 114A and digital-access data 114B) to a data ingestion engine 136 executed by the one or more processors of FI computing system 130. As described herein, the portions of interaction data 112 and interaction data 114 (and the additional, or alternate, portions of the customer profile, account, transaction, branch-access, and/or digital-access data) may be encrypted, and executed data ingestion engine 136 may perform operations that decrypt each of the encrypted portions of interaction data 112 and interaction data 114 (and the additional, or alternate, portions of the customer profile, account, transaction, branch-access, and/or digital-access data) using a corresponding decryption key, e.g., a private cryptographic key associated with FI computing system 130.

Executed data ingestion engine 136 may also perform operations that store the portions of interaction data 112 (including the data records of customer profile data 112A, account data 112B, and transaction data 112C) and interaction data 114 (including the data records of branch-access data 114A and digital-access data 114B) within aggregated data store 132, e.g., as ingested customer data 138. As illustrated in FIG. 1A, a pre-processing engine 140 executed by the one or more processors of FI computing system 130 may access ingested customer data 138, and perform any of the exemplary processes described herein to access elements of ingested customer data 138 (e.g., the data records of customer profile data 112A, account data 112B, transaction data 112C, branch-access data 114A, and/or digital-access data 114B). In some instances, executed data preprocessing perform any of the exemplary data-processing operations described herein to parse the accessed elements of ingested customer data 138, to selectively aggregate, filter, and process the accessed elements of elements of ingested customer data 138, and to generate consolidated data records 142 that characterize corresponding ones of the customers, their interactions with the financial institution and with other financial institutions, and their interactions with the bank branches, voice-based platforms, or digital platforms maintained by the financial institution during a corresponding temporal interval associated with the ingestion of interaction data 112 and interaction data 114 by executed data ingestion engine 136.

By way of example, executed pre-processing engine 140 may access the data records of customer profile data 112A, account data 112B, transaction data 112C, branch-access data 114A, and/or digital-access data 114B (e.g., as maintained within ingested customer data 138). As described herein, each of the accessed data records may include an identifier of corresponding customer of the financial institution, such as a customer name or an alphanumeric character string, and executed pre-processing engine 140 may perform operations that map each of the accessed data records to a customer identifier assigned to the corresponding customer by FI computing system 130. By way of example, FI computing system 130 may assign a unique, alphanumeric customer identifier to each customer, and executed pre-processing engine 140 may perform operations that parse the accessed data records, identify each of the parsed data records that identifies the corresponding customer using a customer name, and replace that customer name with the corresponding alphanumeric customer identifier.

Executed pre-processing engine 140 may also perform operations that assign a temporal identifier to each of the accessed data records, and that augment each of the accessed data records to include the newly assigned temporal identifier. In some instances, the temporal identifier may associate each of the accessed data records with a corresponding temporal interval, which may be indicative of reflect a regularity or a frequency at which FI computing system 130 ingests the elements of interaction data 112 and interaction data 114 from corresponding ones of source systems 110. For example, executed data ingestion engine 136 may receive elements of confidential customer data from corresponding ones of source systems 110 on a monthly basis (e.g., on the final day of the month), and in particular, may receive and store the elements of interaction data 112 and interaction data 114 from corresponding ones of source systems 110 on Feb. 28, 2022. In some instances, executed pre-processing engine 140 may generate a temporal identifier associated with the regular, monthly ingestion of interaction data 112 and interaction data 114 on Feb. 28, 2022 (e.g., “Feb. 28, 2022”), and may augment the accessed data records of customer profile data 112A, account data 112B, transaction data 112C, branch-access data 114A, and/or digital-access data 114B to include the generated temporal identifier. The disclosed embodiments are, however, not limited to temporal identifiers reflective of a regular, monthly ingestion of interaction data 112 and interaction data 114 by FI computing system 130, and in other instances, executed pre-processing engine 140 may augment the accessed data records to include temporal identifiers reflective of any additional, or alternative, temporal interval during which FI computing system 130 ingests the elements of interaction data 112 and interaction data 114.

In some instances, executed pre-processing engine 140 may perform further operations that, for a particular customer of the financial institution during the temporal interval (e.g., represented by a pair of the customer and temporal identifiers described herein), obtain one or more the data records of customer profile data 112A, account data 112B, transaction data 112C, branch-access data 114A, and/or digital-access data 114B that include the pair of customer and temporal identifiers. Executed pre-processing engine 140 may perform operations that consolidate the one or more obtained data records and generate a corresponding one of consolidated data records 142 that includes the customer identifier and temporal identifier, and that is associated with, and characterizes, the particular customer of the financial institution during the temporal interval associated with the temporal identifier. By way of example, executed pre-processing engine 140 may consolidate the obtained data records, which include the pair of customer and temporal identifiers, through an invocation of an appropriate Java-based SQL “join” command (e.g., an appropriate “inner” or “outer” join command, etc.). Further, executed pre-processing engine 140 may perform any of the exemplary processes described herein to generate another one of consolidated data records 142 for each additional, or alternate, customer of the financial institution during the temporal interval (e.g., as represented by a corresponding customer identifier and the temporal interval).

Executed pre-processing engine 140 may perform operations that store each of consolidated data records 142 within one or more tangible, non-transitory memories of FI computing system 130, such as consolidated data store 144. Consolidated data store 144 may, for instance, correspond to a data lake, a data warehouse, or another centralized repository established and maintained, respectively, by the distributed components of FI computing system 130, e.g., through a Hadoop™ distributed file system (HDFS). In some instances, and as described herein, consolidated data records 142 may include a plurality of discrete data records, each of these discrete data records may be associated with, and may maintain data characterizing, a corresponding one of the customers of the financial institution during the corresponding temporal interval (e.g., a month-long interval extending from Feb. 1, 2022, to Feb. 28, 2022). For example, and for a particular customer of the financial institution, discrete data record 142A of consolidated data records 142 may include a customer identifier 146 of the particular customer (e.g., an alphanumeric character string “CUSTID”), a temporal identifier 148 of the corresponding temporal interval (e.g., a numerical string “Feb. 28, 2022”), and consolidated elements 150 of customer profile, account, transaction, branch-access, and/or digital-access data that characterize the particular customer during the corresponding temporal interval (e.g., as consolidated from the data records of customer profile data 112A, account data 112B, transaction data 112C, branch-access data 114A, and/or digital-access data 114B ingested by FI computing system 130 on Feb. 28, 2022).

Further, in some instances, consolidated data store 144 may maintain each of consolidated data records 142, which characterize corresponding ones of the customers, their interactions with the financial institution and with other financial institutions, and any associated acquisition events during the temporal interval, in conjunction with additional consolidated data records 152. Executed pre-processing engine 140 may perform any of the exemplary processes described herein to generate each of the additional consolidated data records 152, including based on elements of profile, account, transaction, credit-bureau, and/or acquisition data ingested from source systems 110 during the corresponding prior temporal intervals.

Further, and as described herein, each of additional consolidated data records 152 may also include a plurality of discrete data records that are associated with and characterize a particular one of the customers of the financial institution during a corresponding one of the prior temporal intervals. For example, as illustrated in FIG. 1A, additional consolidated data records 152 may include one or more discrete data records, such as discrete data record 154, associated with a prior temporal interval extending from Jan. 1, 2022, to Jan. 31, 2022. For the particular customer, discrete data record 154 may include a customer identifier 156 of the particular customer (e.g., an alphanumeric character string “CUSTID”), a temporal identifier 158 of the prior temporal interval (e.g., a numerical string “Jan. 31, 2022”), and consolidated elements 160 of customer profile, account, transaction, branch-access, and/or digital-access data that characterize the particular customer during the prior temporal interval extending from Jan. 1, 2022, to Jan. 31, 2022 (e.g., as consolidated from the data records ingested by FI computing system 130 on Jan. 31, 2022).

The disclosed embodiments are, however, not limited to the exemplary consolidated data records described herein, or to the exemplary temporal intervals described herein. In other examples, FI computing system 130 may generate, and the consolidated data store 144 may maintain any additional or alternate number of discrete sets of consolidated data records, having any additional or alternate composition, that would be appropriate to the data records of customer profile, account, transaction, branch-access, and/or digital-access data ingested by FI computing system 130 at the predetermined intervals described herein. Further, in some examples, FI computing system 130 may ingest data records of customer profile, account, transaction, branch-access, and/or digital-access data from source systems 110 at any additional, or alternate, fixed or variable temporal interval that would be appropriate to the ingested data or to the adaptive training of the machine learning or artificial intelligence processes described herein.

In some instances, FI computing system 130 may perform any of the exemplary operations described herein to adaptively train a machine-learning or artificial-intelligence process to predict a likelihood of an occurrence of each of a plurality of predetermined, targeted acquisition events involving a customer of the financial institution during a future temporal interval using training datasets associated with a first prior temporal interval (e.g., a “training” interval), and using validation datasets associated with a second, and distinct, prior temporal interval (e.g., an out-of-time “validation” interval). As described herein, the machine-learning or artificial-intelligence process may include an ensemble or decision-tree process, such as a gradient-boosted decision-tree process (e.g., the XGBoost process), and the training and validation datasets may include, but are not limited to, values of adaptively selected features obtained, extracted, or derived from the consolidated data records maintained within consolidated data store 144, e.g., from data elements maintained within the discrete data records of consolidated data records 142 or the additional consolidated data records 152.

By way of example, the customer of the financial institution may hold a checking account issued by the financial institution (e.g., a “primary” checking account) which may hold funds denominated a corresponding currency, such as Canadian or U.S. dollars, and the plurality of predetermined, targeted acquisition events may include, but are not limited to, a first targeted acquisition event associated with an acquisition, by the customer, of an additional checking account issued by the financial institution and (e.g., a “secondary” checking account) holding funds denominated in a first currency (e.g., Canadian dollars), a second targeted acquisition event associated with an acquisition, by the customer, of a secondary checking account issued by the financial institution and holdings funds denominated in a second currency (e.g., U.S. dollars), and a third targeted acquisition event associated with a failure of the customer to acquire a secondary checking account issued by the financial institution. As described herein, the customer of the financial institution may “acquire” a secondary checking account upon a successful completion of a corresponding application process performed or implemented by the financial institution.

In some instances, and through an implementation of one or more of the exemplary processes described herein, FI computing system 130 may train, adaptively and simultaneously, a gradient-boosted decision-tree process (e.g., the XGBoost process) to predict, at a corresponding temporal prediction point, (i) a likelihood of an occurrence of the first targeted acquisition event involving the customer during the future temporal interval (e.g., the acquisition of the secondary checking account holding funds denominated in the first currency), (ii) a likelihood of an occurrence of the second targeted acquisition event involving the customer during the future temporal interval (e.g., the acquisition of the secondary checking account holding funds denominated in the second currency), and (iii) a likelihood of an occurrence of the third targeted acquisition event involving the customer during the future temporal interval (e.g., the failure to acquire the secondary checking account) using the training datasets associated with the training interval, and using the validation datasets associated with validation interval. For example, the distributed computing components of FI computing system 130 (e.g., that include one or more GPUs or TPUs configured to operate as a discrete computing cluster) may perform any of the exemplary processes described herein to adaptively train the machine learning or artificial intelligence process (e.g., the gradient-boosted, decision-tree process) in parallel through an implementation of one or more parallelized, fault-tolerant distributed computing and analytical processes. Based on an outcome of these adaptive training processes, FI computing system 130 may generate model coefficients, parameters, thresholds, and other modelling data that collectively specify the trained machine learning or artificial intelligence process, and may store the generated model coefficients, parameters, thresholds, and modelling data within a portion of the one or more tangible, non-transitory memories, e.g., within consolidated data store 144.

Further, upon application of the trained gradient-boosted, decision-tree process to an input dataset associated with the customer of the financial institution, the distributed computing components of FI computing system 130 may perform any of the exemplary processes described herein to generate elements to output data that include, among other things, a numerical value indicative of the predicted likelihood of the occurrence of each of the first targeted acquisition event, the second targeted acquisition event, or the third targeted acquisition event involving the customer during the future temporal interval. In some examples, each of the numerical values may range from zero to unity, and the numerical values characterizing the predicted likelihoods of the occurrences of the first, second, and third targeted acquisition events involving the customer (e.g., that holds the primary checking account) during the future temporal interval may sum to unity.

Referring to FIG. 1B, a training engine 162 executed by the one or more processors of FI computing system 130 may access the consolidated data records maintained within consolidated data store 144, such as, but not limited to, the discrete data records of consolidated data records 142 or additional consolidated data records 152. As described herein, each of the consolidated data records, such as discrete data record 142A of consolidated data records 142 or discrete data record 154 of additional consolidated data records 152, may include a customer identifier of a corresponding one of the customers of the financial institution (e.g., customer identifiers 146 and 156 of FIG. 1A) and a temporal identifier that associates the consolidated data record with a corresponding temporal interval (e.g., temporal identifiers 148 and 158 of FIG. 1A). Further, as described herein, each of the accessed consolidated data records may include consolidated elements of customer profile, account, transaction, credit-bureau, and/or acquisition data that characterize the corresponding one of the customers during the corresponding temporal interval (e.g., consolidated elements 150 and 160 of FIG. 1A).

In some instances, executed training engine 162 may parse the accessed consolidated data records, and based on corresponding ones of the temporal identifiers, determine that the consolidated elements of customer profile, account, transaction, branch-access, and/or digital-access data characterize the corresponding customers across a range of prior temporal intervals. Further, executed training engine 162 may also perform operations that decompose the determined range of prior temporal intervals into a corresponding first subset of the prior temporal intervals (e.g., the “training” interval described herein) and into a corresponding second, subsequent, and disjoint subset of the prior temporal intervals (e.g., the “validation” interval described herein). For example, as illustrated in FIG. 1C, the range of prior temporal intervals (e.g., shown generally as Δt along timeline 163 of FIG. 1C) may be bounded by, and established by, temporal boundaries tᵢ and t_{f}. Further, the decomposed first subset of the prior temporal intervals (e.g., shown generally as training interval Δt_{training} along timeline 163 of FIG. 1C) may be bounded by temporal boundary tᵢ and a corresponding splitting point tₛₚₗᵢₜ along timeline 163, and the decomposed second subset of the prior temporal intervals (e.g., shown generally as validation interval Δt_{validation} along timeline 163 of FIG. 1C) may be bounded by splitting point tₛₚₗᵢₜ and temporal boundary t_{f}.

Referring back to FIG. 1B, executed training engine 162 may generate elements of splitting data 164 that identify and characterize the determined temporal boundaries of the consolidated data records maintained within consolidated data store 144 (e.g., temporal boundaries tᵢ and t_{f}) and the range of prior temporal intervals established by the determined temporal boundaries Further, the elements of splitting data 164 may also identify and characterize the splitting point (e.g., the splitting point tₛₚₗᵢₜ described herein), the first subset of the prior temporal intervals (e.g., the training interval Δt_{training} and corresponding boundaries described herein), and the second, and subsequent subset of the prior temporal intervals (e.g., the validation interval Δt_{validation} and corresponding boundaries described herein). As illustrated in FIG. 1B, executed training engine 162 may store the elements of splitting data 164 within the one or more tangible, non-transitory memories of FI computing system 130, e.g., within consolidated data store 144.

As described herein, each of the prior temporal intervals may correspond to a one-month interval, and executed training engine 162 may perform operations that establish adaptively the splitting point between the corresponding temporal boundaries such that a predetermined first percentage of the consolidated data records are associated with temporal intervals (e.g., as specified by corresponding ones of the temporal identifiers) disposed within the training interval, and such that a predetermined second percentage of the consolidated data records are associated with temporal intervals (e.g., as specified by corresponding ones of the temporal identifiers) disposed within the validation interval. For example, the first predetermined percentage may correspond to seventy percent or eighty-five of the consolidated data records, and the second predetermined percentage may corresponding to thirty percent or fifteen percent of the consolidated data records, although in other examples, executed training engine 162 may compute one or both of the first and second predetermined percentages, and establish the decomposition point, based on the range of prior temporal intervals, a quantity or quality of the consolidated data records maintained within consolidated data store 144, or a magnitude of the temporal intervals (e.g., one-month intervals, two-week intervals, one-week intervals, one-day intervals, etc.).

In some examples, a training input module 166 of executed training engine 162 may perform operations that access the consolidated data records maintained within consolidated data store 144. As described herein, each of the accessed data records (e.g., the discrete data records within consolidated data records 142 or additional consolidated data records 152) characterize a customer of the financial institution (e.g., identified by a corresponding customer identifier), the interactions of the customer with the financial institution and with financial products issued by that financial institution (or by other financial institutions), and the interactions of the customer with one or more bank branches, voice-based platforms, or digital platforms of the financial institution during a particular temporal interval (e.g., associated with a corresponding temporal identifier). In some instances, and based on portions of splitting data 164, executed training input module 166 may perform operations that parse the consolidated data records and determine: (i) a first subset 168A of these consolidated data records are associated with the training interval Δt_{training} and may be appropriate to training adaptively the gradient-boosted decision model during the training interval; and a (ii) second subset 168B of these consolidated data records are associated with the validation interval Δt_{validation} and may be appropriate to validating the adaptively trained gradient-boosted decision model during the validation interval.

As described herein, FI computing system 130 may perform operations that adaptively train a machine-learning or artificial-intelligence process (e.g., the gradient-boosted, decision-tree process described herein) to predict, at a temporal prediction point during a current temporal interval, a likelihood of an occurrence of each of a plurality of predetermined, targeted acquisition events involving a customer of the financial institution (e.g., each of the first, second, and third targeted acquisition events described herein) during a future temporal interval using training datasets associated with the training interval, and using validation datasets associated with the validation interval. For example, and as illustrated in FIG. 1D, the current temporal interval may be characterized by a temporal prediction point t_{pred} along timeline 163, and the executed training engine 162 may perform any of the exemplary processes described herein to train adaptively machine-learning or artificial-intelligence process (e.g., the gradient-boosted, decision-tree process described herein) to predict the likelihood of the occurrence of each of the plurality of predetermined, targeted acquisition events during a future, target temporal interval Δt_{target} based on input datasets associated with a corresponding prior extraction interval Δt_{extract}. Further, as illustrated in FIG. 1D, the target temporal interval Δt_{target} may be separated temporally from the temporal prediction point t_{pred} by a corresponding buffer interval Δt_{buffer}.

By way of example, the target temporal interval Δt_{target} may be characterized by a predetermined duration, such as, but not limited to, one month, and the prior extraction interval Δt_{extract} may be characterized by a corresponding, predetermined duration, such as, but not limited to, three months. Further, in some examples, the buffer interval Δt_{buffer} may also be associated with a predetermined duration, such as, but not limited to, one months, and the predetermined duration of buffer interval Δt_{buffer} may established by FI computing system 130 to separate temporally the customers' prior interactions with the financial institution and financial products issued by the financial institution (and by other financial institutions) from the future target temporal interval Δt_{target}. The disclosed embodiments are not limited to prior extraction intervals, buffer intervals, and target intervals characterized by these exemplary predetermined durations, and in other examples, prior extraction interval Δt_{extract}, buffer interval Δt_{buffer}, and future target temporal interval Δt_{target} may be characterized by any additional, or alternate durations appropriate to the machine learning or artificial intelligence process (e.g., the XGBoost process described herein) and to the consolidated data records maintained within consolidated data store 144.

Referring back to FIG. 1B, executed training input module 166 may perform operations that access the consolidated data records maintained within consolidated data store 144, and may obtain elements of targeting data 167 that identify and characterize each of the plurality of targeted acquisition events, as described herein. By way of example, the elements of targeting data 167 may include information that identifies and characterizes: (i) the first targeted acquisition event associated with the acquisition, by the customer, of a secondary checking account holding funds denominated in the first currency (e.g., Canadian dollars); (ii) the second targeted acquisition event associated with the acquisition, by the customer, of a secondary checking account issued by the financial institution and holdings funds denominated in the second currency (e.g., U.S. dollars); and (iii) a third targeted acquisition event associated with a failure of the customer to acquire a secondary checking account issued by the financial institution and holding funds denominated in either the first or second currencies.

In some instances, executed training input module 166 may parse each of the consolidated data records to obtain a corresponding customer identifier (e.g., which associates with the consolidated data record with a corresponding one of the customers of the financial institution) and a corresponding temporal identifier (e.g., which associated the consolidated data record with a corresponding temporal interval). For example, and based on the obtained customer and temporal identifiers, executed training input module 166 may generate sets of segmented data records associated with corresponding ones of the customer identifiers (e.g., customer-specific sets of segmented data records), and within each set of segmented data records, executed training input module 166 may order the consolidated data records sequentially in accordance with the obtained temporal interval. Through these exemplary processes, executed training input module 166 may generate sets of customer-specific, sequentially ordered data records (e.g., data tables), which executed training input module 166 may maintain locally within the consolidated data store 144 (not illustrated in FIG. 1B).

Further, executed training input module 166 may perform operations that filter the sequentially ordered, consolidated data records within each of the customer-specific sets in accordance with one or more filtration criteria, and that augment the filtered and sequentially ordered data records within each of the customer-specific sets to include additional information characterizing a ground truth associated with the corresponding customer and temporal interval (as established by the corresponding pair of customer and temporal identifiers). For example, and for a particular one of the sequentially ordered, consolidated data records, such as discrete data record 142A of consolidated data records 142, executed training input module 166 may obtain customer identifier 146 (e.g., “CUSTID”), which identifies the corresponding customer, and temporal identifier 148, which indicates data record 142A is associated with the temporal interval extending between Feb. 1, 2022, and Feb. 28, 2022.

Based on customer identifier 146 and temporal identifier 148, executed training input module 166 may access aggregated data store 132 and obtain elements of account data, such as, but not limited to, data records of account data 112B maintained in ingested customer data 138, that include customer identifier 146 and that identify and characterize financial products held or acquired by the corresponding customer across multiple temporal intervals. Further, executed training input module 166 may parse those obtained elements of account data associated with the corresponding customer (e.g., that include customer identifier 146) and determine whether the corresponding customer holds a checking account issued by the financial institution (e.g., a primary checking account) during the temporal interval specified by temporal identifier 148 (e.g., the temporal interval extending from Feb. 1, 2022, to Feb. 28, 2022), during the corresponding future buffer interval Δt_{buffer} (e.g., within a one-month interval subsequent to the temporal interval specified by temporal identifier 148), and within the target interval Δt_{target} (e.g., a one-month interval disposed between one and two months subsequent to the temporal interval specified by temporal identifier 148). If, for example, executed training input module 166 were to determine that the corresponding customer fails to hold a primary checking account issued by the financial institution during the temporal interval specified by temporal identifier 148, and during the future buffer interval A tbuffer and the target interval Δt_{target} associated with that temporal interval, executed training input module 166 may deem data record 142A as being unsuitable for training or validation the machine learning or artificial intelligence processes described herein, and may perform operations that exclude data record 142A from the sequentially ordered, consolidated data records associated with the customer.

Alternatively, if executed training input module 166 were to determine that the corresponding customer holds a primary checking account issued by the financial institution during the temporal interval specified by temporal identifier 148, and during the future buffer interval Δt_{buffer} and the target interval Δt_{target} associated with that temporal interval, executed training input module 166 may further parse the obtained elements of account data associated with the corresponding customer (e.g., that include customer identifier 146) and determine whether the corresponding customer acquired a secondary checking account holding funds denominated in either the first currency (e.g., Canadian dollars) or the second currency (e.g., U.S. dollars) during the target interval Δt_{target}, which may be disposed between two and three months subsequent to the temporal interval specified by temporal identifier 148. If, for example, executed training input module 166 were to determine that the corresponding customer failed to acquire a secondary checking account holding funds denominated in the first or second currencies during the target interval Δt_{target}, executed training input module 166 may establish that data record 142A represents a “positive” target for training the gradient-boosted, decision-tree process to predict a likelihood of an occurrence of the third targeted acquisition event involving the corresponding customer during the target interval Δt_{target} and a “negative” target for training the gradient-boosted, decision-tree process to predict a likelihood of an occurrence of either the first or second targeted acquisition events involving the corresponding customer during the target interval Δt_{target}.

In some instances, executed training input module 166 may generate an element of ground-truth data that associates a value of zero with each of the first and second targeted acquisition events specified within targeting data 167 (e.g., indicating that data record 142A represents a negative target for training the gradient-boosted, decision-tree process to predict a likelihood of an occurrence of either the first or second targeted acquisition events involving the corresponding customer during the target interval Δt_{targert}), and that associates a value of unity with the third targeted acquisition eventt specified within targeting data 167 (e.g., indicating that data record 142A represents a positive target for training the gradient-boosted, decision-tree process to predict a likelihood of an occurrence of either the third targeted acquisition event involving the corresponding customer during the target interval Δt_{target}). By example, the generated elements of ground-truth data may include a linear array {0, 0, 1} having indices corresponding, respectively, to the first, second, and third targeted acquisition events within specified within targeting data 167, and having values of zero or unity indicating, respectively, the status of data record 142A as a negative or positive target for training the training the gradient-boosted, decision-tree process to predict the likelihood of the occurrence of a corresponding one of the first, second, or third targeted acquisition events involving the corresponding customer during the target interval Δt_{target}. Although not illustrated in FIG. 1B, executed training input module 166 may modify data record 142A to include the generated element of ground-truth data, e.g., the array {0, 0, 1}.

In other examples, if executed training input module 166 were to determine that the corresponding customer acquires a secondary checking account holding funds denominated in the first or second currencies during the target interval Δt_{target}, executed training input module 166 may perform additional operations to establish that data record 142A represents a positive target for training the machine learning or artificial intelligence process, or to exclude data record 142A from the sequentially ordered, consolidated data records associated with the customer. For instance, and based on the determination that the corresponding customer acquires a secondary checking account holding funds denominated in the first or second currencies during the target interval Δt_{target}, executed training input module 166 may further parse the obtained elements of account data that identify and characterize the acquired secondary account to determine whether the acquired secondary account represents an excluded account, such as, but not limited to, a youth account or a student account.

If executed training input module 166 were to determine that the acquired secondary account represents one of the excluded accounts, executed training input module 166 may deem data record 142A as being unsuitable for training or validation the machine learning or artificial intelligence processes described herein, and may perform operations that exclude data record 142A from the sequentially ordered, consolidated data records associated with the corresponding customer. Alternatively, if executed training input module 166 were to determine that the acquired secondary account fails to represent one of the excluded accounts, executed training input module 166 may further process the obtained elements of account data associated with the corresponding customer to determine a date on which the corresponding customer acquired the secondary checking account, and to confirm that the corresponding customer held both the primary checking account and the acquired secondary checking account for a predetermined pendency period (e.g., ninety days, etc.) subsequent to the acquisition of the secondary checking account, e.g., that the corresponding customer intends to acquire and hold the secondary checking account in addition to, and not as an alternate to, the primary checking account.

For example, if executed training input module 166 were to determine that the corresponding customer cancelled at least one of the primary checking account of the acquired secondary checking account during the predetermined pendency period, executed training input module 166 may determine the corresponding customer does not intends to acquire and hold concurrently the primary and secondary checking accounts. Based on the determined intention of the corresponding customer, executed training input module 166 may establish that data record 142A represents a positive target for training the gradient-boosted, decision-tree process to predict a likelihood of an occurrence of the third targeted acquisition event involving the corresponding customer during the target interval Δt_{target}, and a negative target for training the gradient-boosted, decision-tree process to predict a likelihood of an occurrence of either the first or second targeted acquisition events involving the corresponding customer during the target interval Δt_{target}. Executed training input module 166 may perform any of the exemplary training processes described herein to generate a corresponding element of ground-truth data and to modify data record 142A to include the generated element of ground-truth data, e.g., the array {0, 0, 1}.

In some instances, if executed training input module 166 were to determine that the corresponding customer continues to hold the primary and secondary checking accounts through the predetermined pendency period, executed training input module 166 may establish that data record 142A represents a negative target for training the gradient-boosted, decision-tree process to predict a likelihood of an occurrence of the third targeted acquisition event involving the corresponding customer during the target interval Δt_{target}. Further, when the acquired secondary account corresponding to a checking account holding funds denominated in the first currency (e.g., Canadian dollars), executed training input module 166 may establish that data record 142A represents a positive target for training the gradient-boosted, decision-tree process to predict a likelihood of an occurrence of the first targeted acquisition event involving the corresponding customer during the target interval Δt_{target}, and a negative target for training the gradient-boosted, decision-tree process to predict a likelihood of an occurrence of the second targeted acquisition event involving the corresponding customer during the target interval Δt_{target}.

Executed training input module 166 may perform any of the exemplary processes described herein to generate an additional element of ground-truth data that associates a value of zero with each of the second and third targeted acquisition events specified within targeting data 167 (e.g., indicating that data record 142A represents a negative target for training the gradient-boosted, decision-tree process to predict a likelihood of an occurrence of either the second or third targeted acquisition events involving the corresponding customer during the target interval Δt_{target}), and that associates a value of unity with the first targeted acquisition event specified within targeting data 167 (e.g., indicating that data record 142A represents a positive target for training the gradient-boosted, decision-tree process to predict a likelihood of an occurrence of the first targeted acquisition event involving the corresponding customer during the target interval Δt_{target}). Although not illustrated in FIG. 1B, executed training input module 166 may modify data record 142A to include the generated element of ground-truth data, e.g., an array {1, 0, 0}.

Alternatively, when the acquired secondary account corresponding to a checking account holding funds denominated in the second currency (e.g., U.S. dollars), executed training input module 166 may establish that data record 142A represents a positive target for training the gradient-boosted, decision-tree process to predict a likelihood of an occurrence of the second targeted acquisition event involving the corresponding customer during the target interval Δt_{target} and a negative target for training the gradient-boosted, decision-tree process to predict a likelihood of an occurrence of the first targeted acquisition event involving the corresponding customer during the target interval Δt_{target}. In some instances, executed training input module 166 may perform any of the exemplary processes described herein to generate a further element of ground-truth data that associates a value of zero with each of the first and third targeted acquisition events specified within targeting data 167 (e.g., indicating that data record 142A represents a negative target for training the gradient-boosted, decision-tree process to predict a likelihood of an occurrence of either the first or third targeted acquisition events involving the corresponding customer during the target interval Δt_{target}), and that associates a value of unity with the first targeted acquisition event specified within targeting data 167 (e.g., indicating that data record 142A represents a positive target for training the gradient-boosted, decision-tree process to predict a likelihood of an occurrence of the second targeted acquisition event involving the corresponding customer during the target interval Δt_{target}). Although not illustrated in FIG. 1B, executed training input module 166 may modify data record 142A to include the generated element of ground-truth data, e.g., an array {0, 1, 0}.

Additionally, in some examples, executed training input module 166 may perform any of the exemplary processes described herein to establish that the corresponding customers acquired a non-excluded secondary checking account holding funds denominated in the first currency (e.g., Canadian dollars) and a non-excluded secondary checking account holding funds denominated in the second currency (e.g., U.S. dollars) during the target interval Δt_{target}. As such, while data record 142A may represent a negative target for training the gradient-boosted, decision-tree process to predict a likelihood of an occurrence of the third targeted acquisition event involving the corresponding customer during the target interval Δt_{target}, data record 142A may represent a positive target for training the gradient-boosted, decision-tree process to predict a likelihood of an occurrence of each of the first and second targeted acquisition events involving the corresponding customer during the target interval Δt_{target}. Executed training input module 166 may perform any of the exemplary processes described herein to generate, and include within data record 142A, an element of ground-truth data that associates a value of zero with the third targeted acquisition event specified within targeting data 167, and that associates a value of unity with the first and second targeted acquisition event specified within targeting data 167, e.g., an array {1, 1, 0}.

Executed training input module 166 may also apply one or more of these exemplary filtration criteria to additional, or alternate, ones of the sequentially ordered, consolidated data records associated with customer identifier 146, and to additional, or alternate, ones of the sequentially ordered, consolidated data records within others of the customer-specific sets. Further, the disclosed embodiments are not limited to these exemplary exclusion criteria, as described herein, and in other examples, executed training input module 166 may filter the sequentially ordered, consolidated data records within each of the customer-specific sets in accordance with any additional, or alternate, filtration criteria appropriate to the machine learning or artificial intelligence process, the targeted classes of acquisition events, and the consolidated data records. Executed training input module 166 may also perform any of the exemplary processes to augment each additional, or alternate, one of the filtered and sequentially ordered data records within each of the customer-specific sets to include elements of ground-truth data characterizing a ground truth associated with the corresponding customer and temporal interval (e.g., the linear arrays described herein).

Executed training input module 166 may also perform operations that partition the customer-specific sets of filtered and sequentially ordered data records into subsets suitable for training adaptively the gradient-boosted, decision-tree process (e.g., which may be maintained in first subset 168A of consolidated data records within consolidated data store 144) and for validating the adaptively trained, gradient-boosted, decision-tree process (e.g., which may be maintained in second subset 168B of consolidated data records within consolidated data store 144). By way of example, executed training input module 166 may access splitting data 164, and establish the temporal boundaries for the training interval Δt_{training} (e.g., temporal boundary tᵢ and splitting point tₛₚₗᵢₜ) and the validation interval Δt_{training} (e.g., splitting point tₛₚₗᵢₜ and temporal boundary t_{f}). Further, executed training input module 166 may also parse each of the sequentially ordered data records of the customer-specific sets, access the corresponding temporal identifier, and determine the temporal interval associated with the each of sequentially ordered data records.

If, for example, executed training input module 166 were to determine that the temporal interval associated with a corresponding one of the sequentially ordered data records is disposed within the temporal boundaries for the training interval Δt_{training}, executed training input module 166 may determine that the corresponding data record may be suitable for training, and may perform operations that include the corresponding data record within a portion of the first subset 168A (e.g., that store the corresponding data record within a portion of consolidated data store 144 associated with first subset 168A). Alternatively, if executed training input module 166 were to determine that the temporal interval associated with a corresponding one of the sequentially ordered data records is disposed within the temporal boundaries for the validation interval Δt_{validation}, executed training input module 166 may determine that the corresponding data record may be suitable for validation, and may perform operations that include the corresponding data record within a portion of the second subset 168B (e.g., that store the corresponding data record within a portion of consolidated data store 144 associated with second subset 168B). Executed training input module 166 may perform any of the exemplary processes described herein to determine the suitability of each additional, or alternate, one of the sequentially ordered data records of the customer-specific sets for adaptive training, or alternatively, validation, of the gradient-boosted, decision-tree process.

In some instances, the consolidated data records within first subset 168A and second subset 168B may represent an imbalanced data set in which actual occurrences of the third targeted acquisition event involving customers of the financial institution during the target interval Δt_{target} outnumber disproportionately actual occurrences of the first and second targeted acquisition events involving the customers of the financial institution during the target interval Δt_{target}. Based on the imbalanced character of first subset 168A and second subset 168B, executed training input module 166 may perform operations that downsample the consolidated data records within first subset 168A and second subset 168B that are associated with the actual occurrences of the third targeted acquisition event. By way of example, the downsam pled data records within first subset 168A and second subset 168B may maintain, for each of the customers of the financial institution, a predetermined maximum number of data records that characterize actual occurrences of the third targeted acquisition event associated with the failure to acquire the secondary checking account (e.g., two data records per customer, etc.). In some instances, the downsampled data records maintained within each first subset 168A and second subset 168B may represent balanced data sets characterized by a more proportionate balance between the actual occurrences of the first, second, and third targeted acquisition events involving customers of the financial institution during the target interval Δt_{target}.

Referring back to FIG. 1B, executed training input module 166 may perform operations that generate a plurality of training datasets 170 based on elements of data obtained, extracted, or derived from all or a selected portion of first subset 168A of the consolidated data records. In some instances, the plurality of training datasets 170 may, when provisioned to an input layer of the gradient-boosted decision-tree process described herein, enable executed training engine 162 to train adaptively the gradient-boosted decision-tree process to predict, at a temporal prediction point during a current temporal interval, a likelihood of an occurrence of each of a plurality of predetermined, targeted acquisition events involving customers of the financial institution during a future temporal interval. By way of example, each of the plurality of training datasets 170 may be associated with a corresponding one of the customers of the financial institution and a corresponding temporal interval, and may include, among other things a customer identifier associated with that corresponding customer and a temporal identifier representative of the corresponding temporal interval, as described herein.

Each of the plurality of training datasets 170 may also include elements of data (e.g., feature values) that characterize the corresponding one of the customers, the corresponding customer's interaction with the financial institution or with unrelated financial institutions, and/or the corresponding customer's interaction with the financial products issued by the financial institution or by unrelated financial institutions during a temporal interval disposed prior to the corresponding temporal interval, e.g., prior extraction interval Δt_{extract}. Further, each of training datasets 170 may also be associated with an element of ground-truth data 171 indicative of an actual occurrence of one or more of the first, second, or third targeted acquisition events during the future target interval Δt_{target} (e.g., the element of ground-truth data maintained within corresponding ones of the consolidated data records, including, but not limited to, the linear arrays described herein).

In some instances, executed training input module 166 may perform operations that identify, and obtain or extract, one or more of the features values from the consolidated data records maintained within first subset 168A and associated with the corresponding one of the customers. The obtained or extracted feature values may, for example, include elements of the customer profile, account, transaction, credit-bureau, and/or acquisition data described herein (e.g., which may populate the consolidated data records maintained within first subset 168A), and examples of these obtained or extracted feature values may include, but are not limited to, demographic data characterizing the corresponding customer (e.g., a customer age, etc.), data characterizing a relationship between the customer and the financial institution (e.g., a customer tenure, etc.), data identifying and characterizing financial products held by the corresponding customer (e.g., a customer tenure associated with a checking or savings account, etc.), a balance or an amount of available credit (or funds) associated with one or more financial instruments held by the corresponding customer, and/or values characterizing an interaction between the corresponding customer and bank branches of the financial institution, voice-based platforms of the financial institution, or digital platforms of the financial institution (e.g., transactions amounts associated with deposit, withdrawal, or bill-payment transactions initiated at bank branches, automated teller machines (ATMs), or digital platforms, currencies associated with these initiated deposit, withdrawal, or bill-payment transactions, etc.). These disclosed embodiments are, however, not limited to these examples of obtained or extracted feature values, and in other instances, training datasets 170 may include any additional or alternate element of data extracted or obtained from the consolidated data records of first subset 168A, associated with corresponding one of the customers, and associated with the extraction interval Δt_{extract} described herein.

Further, in some instances, executed training input module 166 may perform operations that compute, determine, or derive one or more of the features values based on elements of data extracted or obtained from the consolidated data records maintained within first subset 168A. Examples of these computed, determined, or derived feature values may include, but are not limited to, time-averaged values of payments associated with one or more financial products held by the corresponding customer, time-averaged balances associated with these financial products, time-averaged spending (e.g., on an aggregate basis, or on a merchant- or product-specific basis., etc.) or time-averaged cash flow associated with these financial products, sums of balances held in various demand or deposit accounts by corresponding ones of the customers, and/or time-averaged transaction amounts associated with deposits, withdrawals, or bill-payment transactions initiated at bank branches or via digital platforms. These disclosed embodiments are, however, not limited to these examples of computed, determined, or derived feature values, and in other instances, training datasets 170 may include any additional or alternate featured computed, determine, or derived from data extracted or obtained from the consolidated data records of first subset 168A, associated with corresponding one of the customers, and associated with the extraction interval Δt_{extract} described herein.

Executed training input module 166 may provide training datasets 170, the corresponding elements of ground-truth data 171, and the elements of targeting data 167 as inputs to an adaptive training and validation module 172 of executed training engine 162. In some instances, and upon execution by the one or more processors of FI computing system 130, adaptive training and validation module 172 may perform operations that establish a plurality of nodes and a plurality of decision trees for the gradient-boosted, decision-tree process, with may ingest and process the elements of training data (e.g., the customer identifiers, the temporal identifiers, the feature values, etc.) maintained within each of the plurality of training datasets 170. Further, and based on the execution of adaptive training and validation module 172, and on the ingestion of each of training datasets 170 by the established nodes of the gradient-boosted, decision-tree process, FI computing system 130 may perform operations that adaptively train the gradient-boosted, decision-tree process in accordance with the elements of targeting data 167 and against the elements of training data included within each of training datasets 170 and corresponding elements of ground-truth data 171. In some examples, during the adaptive training of the gradient-boosted, decision-tree process, executed adaptive training and validation module 172 may perform operations that characterize a relative of importance of discrete features within one or more of training datasets 170 through a generation of corresponding Shapley feature values and through a generation of values of probabilistic metrics that average a computed area under curve for receiver operating characteristic (ROC) curves across corresponding pairs of the targeted classes of acquisition events, such as, but limited to a value of a multiclass, one-versus-all area under curve (MAUC) computed for one or more of the training datasets.

In some instances, the distributed components of FI computing system 130 may execute adaptive training and validation module 172, and may perform any of the exemplary processes described herein in parallel to adaptively train the gradient-boosted, decision-tree process against the elements of training data included within each of training datasets 170. The parallel implementation of adaptive training and validation module 172 by the distributed components of FI computing system 130 may, in some instances, be based on an implementation, across the distributed components, of one or more of the parallelized, fault-tolerant distributed computing and analytical protocols described herein (e.g., the Apache Spark™ distributed, cluster-computing framework, etc.).

Through the performance of these adaptive training processes, executed adaptive training and validation module 172 may perform operations that compute one or more candidate process parameters that characterize the adaptively trained, gradient-boosted, decision-tree process, and package the candidate process parameters into corresponding portions of candidate process data 174. In some instances, the candidate process parameters included within candidate process data 174 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, executed adaptive training and validation module 172 may also generate candidate input data 176, which specifies a candidate composition of an input dataset for the adaptively trained, gradient-boosted, decision-tree process (e.g., which be provisioned as inputs to the nodes of the decision trees of the adaptively trained, gradient-boosted, decision-tree process).

As illustrated in FIG. 1B, executed adaptive training and validation module 172 may provide candidate process data 174 and candidate input data 176 as inputs to executed training input module 166 of training engine 162, which may perform any of them exemplary processes described herein to generate a plurality of validation datasets 178 having compositions consistent with candidate input data 176 and associated elements of ground-truth data 179 indicative of actual occurrences of the first, second, and third targeted acquisition events during the corresponding future target interval Δt_{targe}t. As described herein, the plurality of validation datasets 178 and the elements of ground-truth data 179 may, when provisioned to, and ingested by, the nodes of the decision trees of the adaptively trained, gradient-boosted, decision-tree process, enable executed training engine 162 to validate the predictive capability and accuracy of the adaptively trained, gradient-boosted, decision-tree process, for example, based on the elements of ground-truth data 179 associated with corresponding ones of the validation datasets 178, or based on one or more computed metrics, such as, but not limited to, computed precision values, computed recall values, computed areas under curve (AUCs) for receiver operating characteristic (ROC) curves or precision-recall (PR) curves, and/or computed multiclass, one-versus-all areas under curve (MAUC) for ROC curves.

By way of example, executed training input module 166 may parse candidate input data 176 to obtain the candidate composition of the input dataset, which not only identifies the candidate elements of customer-specific data included within each validation dataset (e.g., the candidate feature values described herein), but also a candidate sequence or position of these elements of customer-specific data within the validation dataset. Examples of these candidate feature values include, but are not limited to, one or more of the feature values extracted, obtained, computed, determined, or derived by executed training input module 166 and packaged into corresponding potions of training datasets 170, as described herein.

Further, in some examples, each of the plurality of validation datasets 178 may be associated with a corresponding one of the customers of the financial institution, and with a corresponding temporal interval within the validation interval Δt_{validation}, and executed training input module 166 may access the consolidated data records maintained within second subset 168B of consolidated data store 144, and may perform operations that extract, from an initial one of the consolidated data records, a customer identifier (which identifies a corresponding one of the customers of the financial institution associated with the initial one of the consolidated data records) and a temporal identifier (which identifies a temporal interval associated with the initial one of the consolidated data records). Executed training input module 166 may package the extracted customer identifier and temporal identifier into portions of a corresponding one of validation datasets 178, e.g., in accordance with candidate input data 176.

Executed training input module 166 may perform operations that access one or more additional ones of the consolidated data records that are associated with the corresponding one of the customers (e.g., that include the customer identifier) and as associated with a temporal interval (e.g., based on corresponding temporal identifiers) disposed prior to the corresponding temporal interval, e.g., within the extraction interval textract described herein. Based on portions of candidate input data 176, executed training input module 166 may identify, and obtain or extract one or more of the feature values of the validation datasets from within the additional ones of the consolidated data records within second subset 168B. Further, in some examples, and based on portions of candidate input data 176, executed training input module 166 may perform operations that compute, determine, or derive one or more of the features values based on elements of data extracted or obtained from further ones of the consolidated data records within second subset 168B. Executed training input module 166 may package each of the obtained, extracted, computed, determined, or derived feature values into corresponding positions within the initial one of validation datasets 178, e.g., in accordance with the candidate sequence or position specified within candidate input data 176.

The corresponding one of validation datasets 178 may also be associated with an element of ground-truth data 179 indicative of an actual occurrence of one or more of the first, second, or third targeted acquisition events during the future target interval Δt_{target} (e.g., the element of ground-truth data maintained within the corresponding one of the consolidated data records, including, but not limited to, the linear arrays described herein). For example, executed training input module 166 may parse the initial one of the consolidated data records, extract the element of ground-truth data (e.g., the linear array described herein), and package the extracted element of ground-truth data into the element of ground-truth data 179.

In some instances, executed training input module 166 may perform any of the exemplary processes described herein to generate additional, or alternate, ones of validation datasets 178, and an additional, or alternate, element of ground-truth data 179, based on the elements of data maintained within the consolidated data records of second subset 168B. For example, each of the additional, or alternate, ones of validation datasets 178 may associated with a corresponding, and distinct, pair of customer and temporal identifiers, and as such, corresponding customers of the financial institution and corresponding temporal intervals within validation interval Δt_{validation}. Further, executed training input module 166 may perform any of the exemplary processes described herein to generate an additional, or alternate, ones of validation datasets 178 associated with each unique pair of customer and temporal identifiers maintained within the consolidated data records of second subset 168B, and in other instances a number of discrete validation datasets within validation datasets 178 may be predetermined or specified within candidate input data 176.

Referring back to FIG. 1B, executed training input module 166 may provide the plurality of validation datasets 178 and corresponding elements of ground-truth data 179 as inputs to executed adaptive training and validation module 172. In some examples, executed adaptive training and validation module 172 may perform operations that apply the adaptively trained, gradient-boosted, decision-tree process to respective ones of validation datasets 178 (e.g., based on the candidate process parameters within candidate process data 174, as described herein), and that generate elements of output data based on the application of the adaptively trained, gradient-boosted, decision-tree process to corresponding ones of validation datasets 178.

As described herein, each of the each of elements of output data may be generated through the application of the adaptively trained, gradient-boosted, decision-tree process to a corresponding one of validation datasets 178. Further, as described herein, each of the elements of output data may include a numerical value indicative of the predicted likelihood of the occurrence of each of the first targeted acquisition event, the second targeted acquisition event, or the third targeted acquisition event involving the corresponding one of the customers during the target interval Δt_{target}. As described herein, each of the numerical values may range from zero to unity, and the numerical values characterizing the predicted likelihoods of the occurrences of the first, second, and third targeted acquisition events involving the corresponding one of the customers (e.g., that holds the primary checking account) during the target interval Δt_{target} may sum to unity.

Executed adaptive training and validation module 172 may perform operations that compute a value of one or more metrics that characterize a predictive capability, and an accuracy, of the adaptively trained, gradient-boosted, decision-tree process based on the generated elements of output data, corresponding ones of validation datasets 178, and corresponding elements of ground-truth data 179. The computed metrics may include, but are not limited to, one or more recall-based values for the adaptively trained, gradient-boosted, decision-tree process (e.g., “recall@5,” “recall@10,” “recall@20,” etc.), and additionally, or alternatively, one or more precision-based values for the adaptively trained, gradient-boosted, decision-tree process. Further, in some examples, the computed metrics may include a computed value of an area under curve (AUC) for a precision-recall (PR) curve associated with the adaptively trained, gradient-boosted, decision-tree process, a computed value of an AUC for a receiver operating characteristic (ROC) curve associated with the adaptively trained, gradient-boosted, decision-tree process, and additionally, or alternatively, a computed value of multiclass, one-versus-all area under curve (MAUC) for a ROC curve across the corresponding pairs of the targeted classes of acquisition events associated with the adaptively trained, gradient-boosted, decision-tree process. The disclosed embodiments are, however, not limited to these exemplary computed metric values, and in other instances, executed adaptive training and validation module 172 may compute a value of any additional, or alternate, metric appropriate to validation datasets 178, the elements of ground-truth data, or the adaptively trained, gradient-boosted, decision-tree process

In some examples, executed adaptive training and validation module 172 may also perform operations that determine whether all, or a selected portion of, the computed metric values satisfy one or more threshold conditions for a deployment of the adaptively trained, gradient-boosted, decision-tree process and a real-time application to elements of customer profile, account, transaction, branch-access and/or digital-access data, as described herein. For instance, the one or more threshold conditions may specify one or more predetermined threshold values for the adaptively trained, gradient-boosted, decision-tree mode, such as, but not limited to, a predetermined threshold value for the computed recall-based values, a predetermined threshold value for the computed precision-based values, and/or a predetermined threshold value for the computed AUC values and/or MAUC values. In some examples, executed adaptive training and validation module 172 that establish whether one, or more, of the computed recall-based values, the computed precision-based values, or the computed AUC or MAUC values exceed, or fall below, a corresponding one of the predetermined threshold values and as such, whether the adaptively trained, gradient-boosted, decision-tree process satisfies the one or more threshold requirements for deployment.

If, for example, executed adaptive training and validation module 172 were to establish that one, or more, of the computed metric values fail to satisfy at least one of the threshold requirements, FI computing system 130 may establish that the adaptively trained, gradient-boosted, decision-tree process is insufficiently accurate for deployment and a real-time application to the elements of customer profile, account, transaction, branch-access and/or digital-access data described herein. Executed adaptive training and validation module 172 may perform operations (not illustrated in FIG. 1B) that transmit data indicative of the established inaccuracy to executed training input module 166, which may perform any of the exemplary processes described herein to generate one or more additional training datasets and corresponding elements of ground-truth data, which may be provisioned to executed adaptive training and validation module 172. In some instances, executed adaptive training and validation module 172 may receive the additional training datasets and corresponding elements of ground-truth data, and may perform any of the exemplary processes described herein to train further the gradient-boosted, decision-tree process against the elements of training data included within each of the additional training datasets in accordance with the elements of targeting data 167.

Alternatively, if executed adaptive training and validation module 172 were to establish that each computed metric value satisfies threshold requirements, FI computing system 130 may deem the gradient-boosted, decision-tree process adaptively trained, and ready for deployment and real-time application to the elements of customer profile, account, transaction, branch-access and/or digital-access data described herein. In some examples, executed adaptive training and validation module 172 may also perform operations that, based on a predetermined subset of a parameter space associated with one or more of the process parameters of the adaptively trained, gradient-boosted, decision-tree process, perform a programmatic grid search or parameter sweep that optimizes a value of the one or more of the process parameters, as determined herein. Executed adaptive training and validation module 172 may also generate process data 180 that includes the determined, and in some instances, optimized, process parameters of the adaptively trained, gradient-boosted, decision-tree process, such as, but not limited to, each of the candidate process parameters specified within candidate process data 174. Further, executed adaptive training and validation module 172 may also generate input data 182, which characterizes a composition of an input dataset for the adaptively trained, gradient-boosted, decision-tree process and identifies each of the discrete data elements within the input data set, along with a sequence or position of these elements within the input data set (e.g., as specified within candidate input data 176). As illustrated in FIG. 1B, executed adaptive training and validation module 172 may perform operations that store process data 180 and input data 182 within the one or more tangible, non-transitory memories of FI computing system 130, such as consolidated data store 144.

Further, in some examples, executed adaptive training and validation module 172 may also perform operations that generate one or more elements of explainability data 184 that, among other things, characterize a contribution of each of the discrete explainability features specified within input data 182 to: the predicted likelihood of the occurrence of the first targeted acquisition event involving customers of the financial institution during the target interval Δt_{target} (e.g., first subset 186 of FIG. 1B); the predicted likelihood of the occurrence of the second targeted acquisition event involving the customers during the target interval Δt_{target} (e.g., second subset 188 of FIG. 1B); and the predicted likelihood of the occurrence of the third targeted acquisition event involving the customers during the target interval Δt_{target} (e.g., third subset 190 of FIG. 1B). By way of example, executed adaptive training and validation module 172 may perform operations that compute the relative contribution and importance of each of the discrete features to the predicted likelihoods of the occurrences of respective ones of the first, second, and third targeted acquisition events based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted acquisition events. As illustrated in FIG. 1B, executed training engine 162 may store explainability data 184, including subsets 186, 188, and 190 that characterize contribution and importance of each of the discrete features specified within input data 182 to the predicted likelihoods of the occurrences of respective ones of the first, second, and third targeted acquisition events, within the one or more tangible, non-transitory memories of FI computing system 130, such as consolidated data store 144.

### B. Exemplary Processes for Predicting Future Occurrences of Targeted Events Using Trained, Machine-Learning or Artificial-Intelligence Processes

In some examples, one or more computing systems associated with or operated by a financial institution, such as one or more of the distributed components of Fl computing system 130, may perform operations that adaptively train a machine learning or artificial intelligence process to predict, at a prediction point during a current temporal interval, a likelihood of an occurrence of each of a plurality of predetermined, targeted acquisition events involving a customer of the financial institution during a future temporal interval using training datasets associated with a first prior temporal interval, and using validation datasets associated with a second, and distinct, prior temporal interval. As described herein, the customer of the financial institution may hold a checking account issued by the financial institution (e.g., a “primary” checking account), which may hold funds denominated a corresponding currency, such as Canadian or U.S. dollars, and the plurality of predetermined, targeted acquisition events may include, but are not limited to, a first targeted acquisition event associated with an acquisition, by the customer, of an additional checking account issued by the financial institution and (e.g., a “secondary” checking account) holding funds denominated in a first currency (e.g., Canadian dollars), a second targeted acquisition event associated with an acquisition, by the customer, of a secondary checking account issued by the financial institution and holdings funds denominated in a second currency (e.g., U.S. dollars), and a third targeted acquisition event associated with a failure of the customer to acquire a secondary checking account issued by the financial institution.

Further, and as described herein the machine-learning or artificial-intelligence process may include an ensemble or decision-tree process, such as a gradient-boosted, decision-tree process (e.g., the XGBoost process), and the training and validation datasets may include, but are not limited to, elements of the profile, account, transaction, branch-access, and/or digital-access data characterizing corresponding ones of the customers of the financial institution. In some instances, upon application of the trained gradient-boosted, decision-tree process to an input dataset associated with a particular customer of the financial institution that holds a primary checking account, the distributed computing components of FI computing system 130 may perform any of the exemplary processes described herein to generate elements to output data that include, among other things, a numerical value indicative of the predicted likelihood of the occurrence of each of the first targeted acquisition event, the second targeted acquisition event, or the third targeted acquisition event involving the particular customer during the future temporal interval. Each of the numerical values may, for example, range from zero to unity, and the numerical values characterizing the predicted likelihoods of the occurrences of the first, second, and third targeted acquisition events involving the particular customer during the future temporal interval may sum to unity.

Through the implementation of the exemplary processes described herein, which adaptively train and validate a machine-learning or artificial-intelligence process (such as the gradient-boosted, decision-tree process described herein) using customer-specific training and validation datasets associated with respective training and validation intervals, and which apply the trained and validated machine-learning or artificial-intelligence process to additional customer-specific input datasets, FI computing system 130 may predict, in real-time, a likelihood of an occurrence of each of the first, second, and third targeted acquisition events involving the particular customer during a predetermined, future temporal interval (e.g., via the implementation of the parallelized, fault-tolerant distributed computing and analytical protocols described herein across clusters of GPUs and/or TPUs). These exemplary processes may, for example, provide, to the financial institution, a real-time indication of the predicted likelihood that the particular customer, which holds a primary checking account, will acquire a secondary checking account holding funds denominated in a first or second currency (e.g., the Canadian or U.S. dollars described herein) during a future temporal interval, and may enable one or more additional computing systems of the financial institution to provision, in real-time, digital content associated with the secondary checking account to a device operable by the customer based on the predicted likelihood.

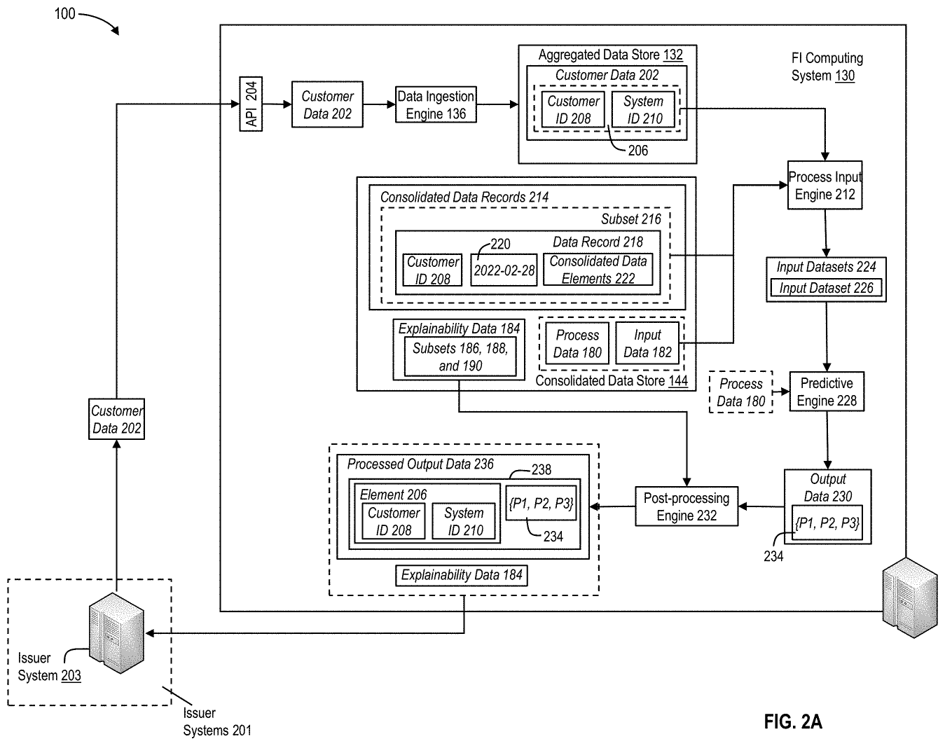

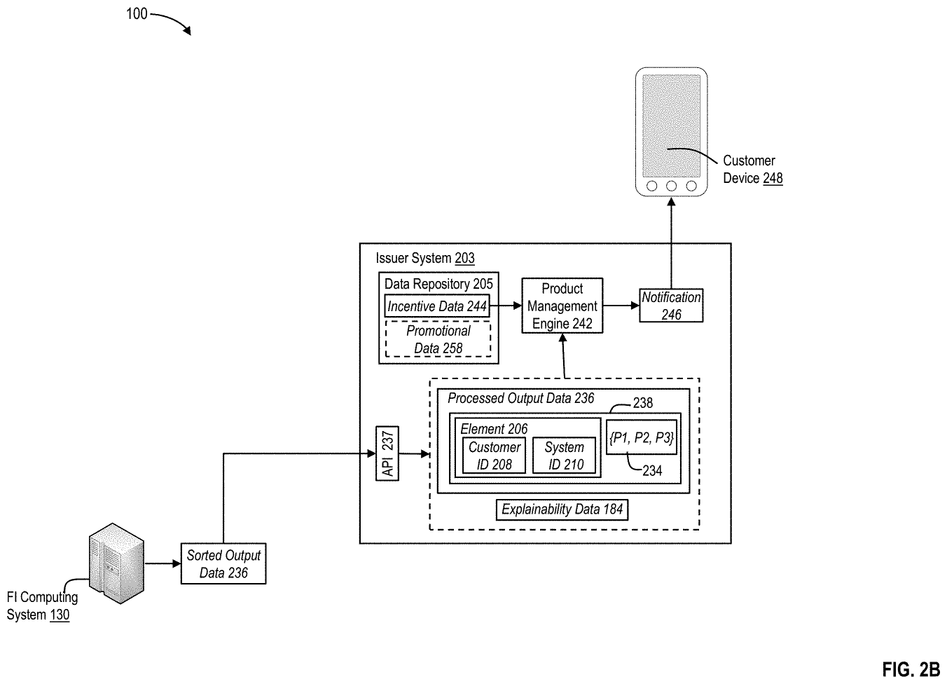

Referring to FIG. 2A, aggregated data store 132 of FI computing system 130 may maintain one or more elements of customer data 202 that identify and characterize corresponding customers of the financial institution, and FI computing system 130 may receive all, or a selected portion, of the elements of customer data 202 from one or more issuer systems 201 associated with the primary checking account (and further with one or more of the secondary checking accounts described herein), such as, but not limited to, issuer system 203 of FIG. 2A. By way of example, each of the customers may represent a customer that hold a primary checking account issued by the financial institution, and in some instances, issuer system 203 may selected all, or a selected subset, based on an application of one or more selection criteria to elements of data characterizing the customers or the primary checking accounts, such as, but not limited to, one or more of the filtration criteria described herein that exclude primary accounts associated with youth or student checking accounts (not illustrated in FIG. 2A).

In some instances, each of issuer systems 201, including issuer system 203, may represent a computing system that includes one or more servers and tangible, non-transitory memories storing executable code and application modules. Further, the one or more servers may each include one or more processors (such as a central processing unit (CPU)), which may be configured to execute portions of the stored code or application modules to perform operations consistent with the disclosed embodiments. Each of issuer systems 201, including issuer system 203, may also include a communications interface, such as one or more wireless transceivers, coupled to the one or more processors for accommodating wired or wireless internet communication with other computing systems and devices operating within environment 100. In some instances, each of issuer systems 201 (including issuer system 203) may be incorporated into a respective, discrete computing system, although in other instances, one or more of issuer systems 201 (such as issuer system 203) may correspond to a distributed computing system having a plurality of interconnected, computing components distributed across an appropriate computing network, such as communications network 120 of FIG. 1A, or to a publicly accessible, distributed or cloud-based computing cluster, such as a computing cluster maintained by Microsoft Azure™, Amazon Web Services™, Google CloudTM, or another third-party provider.

Referring back to FIG. 2A, an application program executed by the one or more processors of issuer system 203, and of additional, or alternate, ones of issuer systems 201, may transmit portions of the elements of customer data 202 across network 120 to FI computing system 130. The transmitted portions may be encrypted using a corresponding encryption key, such as a public cryptographic key associated with FI computing system 130, and a programmatic interface established and maintained by FI computing system 130, such as application programming interface (API) 204, may receive the portions of customer data 202 from issuer system 203, or from additional, or alternate, ones of issuer systems 201.

API 204 may, for example, route each of the elements of customer data 202 to executed data ingestion engine 136, which may perform operations that store the elements of customer data 202 within one or more tangible, non-transitory memories of Fl computing system 130, such as within aggregated data store 132. In some instances, and as described herein, the received elements of customer data 202 may be encrypted, and executed data ingestion engine 136 may perform operations that decrypt each of the encrypted elements of customer data 202 using a corresponding decryption key (e.g., a private cryptographic key associated with FI computing system 130) prior to storage within aggregated data store 132. Further, although not illustrated in FIG. 2A, aggregated data store 132 may also store one or more additional elements of customer data identifying customers of the financial institution that hold corresponding ones of the unsecured credit products, and executed data ingestion engine 136 may perform one or more synchronization operation that merge the received elements of customer data 202 with the previously stored elements of customer data, and that eliminate any duplicate elements existing among the received elements of customer data 202 with the previously stored elements of customer data (e.g., through an invocation of an appropriate Java-based SQL “merge” command).

As described herein, each of the elements of customer data 202 may be associated with, and include a unique identifier of, a customer of the financial institution, and FI computing system 130 may receive each of the elements of customer data 202 from a corresponding one of issuer systems 201, such as issuer system 203. For example, as illustrated in FIG. 2A, element 206 of customer data 202, which may be associated with a particular one of the customers and may be received from issuer system 203, may include a customer identifier 208 assigned to the particular customer by FI computing system 130 (e.g., an alphanumeric character string, etc.), and a system identifier 210 associated with issuer system 203 (e.g., an Internet Protocol (IP) address, a media access control (MAC) address, etc.). Further, although not illustrated in FIG. 2A, each additional, or alternate, element of customer data 202 may be associated with an additional customer of the financial institution that holds an unsecured credit product and received from a corresponding one of issuer systems 201, and may include a customer identifier associated with that additional customer and a system identifier associated with the corresponding one of issuer systems 201.

FI computing system 130 may perform any of the exemplary processes described herein to generate an input dataset associated with each of the customers identified by the discrete elements of customer data 202, and to apply the adaptively trained, gradient-boosted, decision-tree process described herein to each of the input datasets, in accordance with a predetermined temporal schedule (e.g., on a monthly basis), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from one or more of issuer systems 201.

In some instances, and in accordance with the predetermined temporal schedule, or upon detection of the triggering event, a process input engine 212 executed by FI computing system 130 may perform operations that access the elements of customer data 202 maintained within aggregated data store 132, and that obtain the customer identifier maintained within a corresponding one of the accessed elements of customer data 202. For example, as illustrated in FIG. 2A, executed process input engine 212 may access element 206 of customer data 202 (e.g., as maintained within aggregated data store 132) and obtain customer identifier 208, which includes, but is not limited to, the alphanumeric character string assigned to the particular customer of the financial institution.

Executed process input engine 212 may also access consolidated data store 144, and perform operations that identify, within consolidated data records 214, a subset 216 of consolidated data records that include customer identifier 208 and as such, are associated with the particular customer of the financial institution identified by element 206 of customer data 202. As described herein, each of consolidated data records 214 may be associated with a customer of the financial institution, and may characterize that customer, the interaction of that customer with the financial institution and with other financial institutions, and the interaction of that customer with financial products issued by financial institution and with other financial institutions during a corresponding temporal interval. For example, and as described herein, each of consolidated data records 214 may include a corresponding customer identifier (e.g., an alphanumeric character string assigned to a corresponding customer), a corresponding temporal identifier (e.g., that identifies the corresponding temporal interval), and one or more consolidated elements associated with the corresponding customer. Examples of these consolidated elements may include, but are not limited to, elements customer profile data, account data, transaction data, branch-access, or digital-access data, which may be ingested, processed, aggregated, or filtered by FI computing system 130 using any of the exemplary processes described herein.

In some instances, and as illustrated in FIG. 2A, each of subset 216 may include customer identifier 208 and as such, may be associated with the particular customer identified by element 206 of customer data 202. Each of subset 216 of consolidated data records 214 may also include a temporal identifier of a corresponding temporal interval, and one or more consolidated elements associated with the particular customer, the interaction of particular customer with the financial institution and with other financial institutions, and the interaction of that customer with financial products issued by financial institution and with other financial institutions during corresponding ones of the temporal intervals. By way of example, data record 218 of subset 216 may include customer identifier 208, a corresponding temporal identifier 220 (e.g., “Feb. 28, 2022” indicating a temporal interval spanning Feb. 1, 2022, through Feb. 28, 2022). Further, although not illustrated in FIG. 2A, each additional, or alternate, data records within subset 216 may include customer identifier 208, a temporal identifier of a corresponding temporal interval, and corresponding elements of consolidated data that identify and characterize the particular customer during the corresponding temporal interval.

Executed process input engine 212 may also perform operations that obtain, from consolidated data store 144, elements of input data 182 characterize a composition of an input dataset for the adaptively trained, gradient-boosted, decision-tree process. In some instances, executed process input engine 212 may parse input data 182 to obtain the composition of the input dataset, which not only identifies the elements of customer-specific data included within each input data set dataset (e.g., input feature values, as described herein), but also a specified sequence or position of these input feature values within the input dataset. Examples of these input feature values include, but are not limited to, one or more of the candidate feature values extracted, obtained, computed, determined, or derived by executed training input module 166 and packaged into corresponding potions of validation datasets 178, as described herein.

In some instances, and based on the parsed portions of input data 182, executed process input engine 212 may that identify, and obtain or extract, one or more of the input feature values from one or more of data records maintained within subset 216 of consolidated data records 214 and associated with temporal intervals disposed within the extraction interval Δt_{extract}, as described herein. Executed process input engine 212 may perform operations that package the obtained, or extracted, input feature values within a corresponding one of input datasets 224, such as input dataset 226 associated with the particular customer identified by element 206 of customer data 202, in accordance with their respective, specified sequences or positions. Further, in some examples, and based on the parsed portions of input data 182, executed process input engine 212 may perform operations that compute, determine, or derive one or more of the input features values based on elements of data extracted or obtained from the additional ones of the consolidated data records, as described herein. Executed process input engine 212 may perform operations that package each of the computed, determined, or derived input feature values into portions of input dataset 226 in accordance with their respective, specified sequences or positions.

Through an implementation of these exemplary processes, executed process input engine 212 may populate an input dataset associated with the particular customer identified by element 206 of customer data 202, such as input dataset 226 of input datasets 224, with input feature values obtained or extracted from, or computed, determined or derived from element of data within, the data records of subset 216. Further, in some instances, executed process input engine 212 may also perform any of the exemplary processes described herein to generate, and populate with input feature values, an additional one of input datasets 224 for each of the additional, or alternate, customers of the financial institution associated with additional, or alternate, elements of customer data 202. Executed process input engine 212 may package each of the discrete, customer-specific input datasets within input datasets 224, and executed process input engine 212 may provide input datasets 224 as an input to a predictive engine 228 executed by the one or more processors of FI computing system 130.

As illustrated in FIG. 2A, executed predictive engine 228 may perform operations that obtain, from consolidated data store 144, process data 180 that includes one or more process parameters of the adaptively trained, gradient-boosted, decision-tree process. For example, and as described herein, the process parameters included within process data 180 may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters).

In some instances, and based on portions of process data 180, executed predictive engine 228 may perform operations that establish a plurality of nodes and a plurality of decision trees for the adaptively trained, gradient-boosted, decision-tree process, each of which receive, as inputs (e.g., “ingest”), corresponding elements of input datasets 224. Further, and based on the execution of predictive engine 228, and on the ingestion of input datasets 224 by the established nodes and decision trees of the adaptively trained, gradient-boosted, decision-tree process, FI computing system 130 may perform operations that apply the adaptively trained, gradient-boosted, decision-tree process to each of the input datasets of input datasets 224, including input dataset 226, and that generate an element of output data 230 associated with a corresponding one of input datasets 224, and as such, a corresponding one of the customers identified by the elements of customer data 202.

By way of example, each of the generated elements of output data 230 may include a numerical value indicative of the predicted likelihood of an occurrence of each of the first targeted acquisition event (e.g., the acquisition of the secondary checking account holding funds denominated in the first currency), the second targeted acquisition event (e.g., the acquisition of the secondary checking account holding funds denominated in the second currency), and the third targeted acquisition event (e.g., the failure to acquire the secondary checking account) involving the corresponding one of the customers during the future temporal interval (e.g., the target interval Δt_{target}, described herein). As described herein, each of the numerical values may range from zero to unity, and the numerical values characterizing the predicted likelihoods of the occurrences of the first, second, and third targeted acquisition events involving each of the customers (e.g., that holds the primary checking account) during the future temporal interval may sum to unity.

As illustrated in FIG. 2A, executed predictive engine 228 may provide the generated elements of output data 230 (e.g., either alone, or in conjunction with corresponding ones of input datasets 224) as an input to a post-processing engine 232 executed by the one or more processors of FI computing system 130. In some instances, and upon receipt of the generated elements of output data 230 (e.g., and additionally, or alternatively, the corresponding ones of input datasets 224), executed post-processing engine 232 may perform operations that access the elements of customer data 202 maintained within consolidated data store 144, and associate each of the elements of customer data 202 (e.g., that identify a corresponding one of the customers of the financial institution that hold a primary checking account issued by the financial institution) with a corresponding one of the elements of output data 230 (e.g., that include the numerical values indicative of the predicted likelihood of the occurrences of the first, second, and third targeted acquisition events involving the corresponding one of the customers during the future temporal interval).

By way of example, element 234 of output data 230 may be associated with the particular customer identified by element 206 of customer data 202 (and holding a primary checking account issued by the financial institution), and may include: (i) a first numerical value P₁ indicating a predicted likelihood that the particular customer will acquire a secondary checking account holding funds denominated in the first currency (e.g., Canadian dollars) during the future temporal interval (e.g., the predicted likelihood of the occurrence of the first targeted acquisition event during the future temporal interval); (ii) a second numerical value P₂ indicating a predicted likelihood that the particular customer will acquire a secondary checking account holding funds denominated in the second currency (e.g., U.S. dollars) during the future temporal interval (e.g., the predicted likelihood of the occurrence of the second targeted acquisition event during the future temporal interval); and (iii) a third numerical value P₃ indicating a predicted likelihood that the particular customer will fail to acquire a secondary checking account holding funds denominated in the first or second currencies during the future temporal interval (e.g., the predicted likelihood of the occurrence of the third targeted acquisition event during the future temporal interval). As described herein, each of numerical values P₁, P₂, P₃ may range between zero and unity, and in some instances, numerical values P₁, P₂, P₃ may sum to unity.

Further, as illustrated in FIG. 2A, elements 234 may maintain numerical values P₁, P₂, P₃, which characterize the predicted likelihoods of the occurrences of the first, second, and third targeted acquisition events involving the particular customer during the future temporal interval, within a linear array, e.g., {P₁, P₂, P₃} having indices corresponding, respectively, to the first, second, and third targeted acquisition events within specified within targeting data 167. For example, element 234 of output data 230 may include a linear array {0.78, 0.17, and 0.05}, which indicates a 78% probability that the particular customer will acquire a secondary checking account holding funds denominated in Canadian dollars within the future temporal interval (e.g., a one-month interval disposed between one and two months subsequent to the temporal prediction point), a 17% probability that the particular customer will acquire a secondary checking account holding funds denominated in U.S. dollars within the future temporal interval, and a 5% likelihood that the particular customer will fail to acquire a secondary checking in either U.S. or Canadian dollars during the future temporal interval. Each additional, or alternate, elements of output data 230 may include similar numerical values characterizing the predicted likelihoods of the occurrences of the first, second, and third targeted acquisition events involving each an additional, or alternate, one of the customers (e.g., that holds the primary checking account) during the future temporal interval, and may maintain these numerical values within a corresponding linear array.

Executed post-processing engine 232 may, in some instances, associate element 206 of customer data 202 with element 234 of output data 230, and generate an element 238 of processed output data 236 that includes the associated pair of element 206 of customer data 202 with element 234 of output data 230. Executed post-processing engine 232 may also perform any of these exemplary processes to associate each additional, or alternate, one of the elements of output data 230 with a corresponding one of the elements of customer data 202, and to package each additional, or alternate, pair of the elements of customer data 202 and output data 230 into a corresponding element of processed output data 236. In some instances, executed post-processing engine 232 may also access consolidated data store 144, and obtain one or more elements of explainability data 184.

As described herein, the elements of explainability data 184 may characterize a relative contribution of each of the discrete features specified within input data 182 to: the predicted likelihood of the occurrence of the first targeted acquisition event involving customers of the financial institution during the target interval Δt_{target} (e.g., first subset 186 of explainability data 184); the predicted likelihood of the occurrence of the second targeted acquisition event involving the customers during the target interval Δt_{target} (e.g., second subset 188 of explainability data 184); and the predicted likelihood of the occurrence of the third targeted acquisition event involving the customers during the target interval Δt_{target} (e.g., third subset 190 of explainability data 184). In some instances, the relative contribution and importance of each of the discrete features to the predicted likelihoods of the occurrences of respective ones of the first, second, and third targeted acquisition events may be determined (e.g., by executed adaptive training and validation module 172 of FIG. 1B) based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted acquisition events.

As illustrated in FIG. 2A, FI computing system 130 may perform operations that transmit all, or a selected portion of, processed output data 236, including element 238 that maintains the associated pair of element 206 of customer data 202 with element 234 of output data 230, and the one or more elements of explainability data 184 to issuer system 203 and additionally, or alternatively, to other ones of issuer systems 201. By way of example, FI computing system 130 may obtain system identifier included within each of the associated elements of customer data 202 and output data 230 within processed output data 236 (e.g., system identifier 210 maintained within element 238 of processed output data 236), and perform operations that transmit each of the pairs of sorted and associated elements of customer data 202 and output data 230, and the one or more portions of explainability data 184, to a corresponding one of issuer systems 201, including issuer system 203, associated with the obtained system identifier. Further, although not illustrated in FIG. 2A, FI computing system 130 may also encrypt all, or a selected portion of, processed output data 236 and explainability data 184 prior to transmission across network 120 using a corresponding encryption key, such as, but not limited to, a corresponding public cryptographic key associated with a corresponding one of issuer systems 201, such as issuer system 203.

Referring to FIG. 2B, one or more of issuer systems 201, such as issuer system 203, may receive, all, or a selected portion, of processed output data 236 and explainability data 184 from FI computing system 130. For example, a programmatic interface associated with and maintained by issuer system 203, such as application programming interface (API) 237, may receive and route the portions of processed output data 236 and explainability data 184 to a product management engine 242 executed by the one or more processors of issuer system 203. As described herein, processed output data 236 may associate together elements of customer data 202 (e.g., that identify and characterize corresponding customers of the financial institution) and output data 230 (that include the numerical values P₁, P₂, and P₃ indicative of the predicted likelihood of an occurrence of each of the first targeted acquisition event (e.g., the acquisition of the secondary checking account holding funds denominated in the first currency), the second targeted acquisition event (e.g., the acquisition of the secondary checking account holding funds denominated in the second currency), and the third targeted acquisition event (e.g., the failure to acquire the secondary checking account) involving the corresponding the customers during the future temporal interval). Further, and as described herein, the elements of explainability data 184 may characterize a relative contribution of each of the discrete features specified within input data 182 to the predicted likelihood of the occurrence of the first targeted acquisition event during the target interval Δt_{target} (e.g., first subset 186 of explainability data 184); the predicted likelihood of the occurrence of the second targeted acquisition event during the target interval Δt_{target} (e.g., second subset 188 of explainability data 184); and the predicted likelihood of the occurrence of the third targeted acquisition event during the target interval Δt_{target} (e.g., third subset 190 of explainability data 184).

By way of example, and for a particular customer of the financial institution, processed output data 236 may maintain element 238 that associates element 206 of customer data 202 (which includes customer identifier 208 of the particular customer) and element 234 of output data 230 (which includes numerical values P₁, P₂, and P₃ indicative of the predicted likelihood of an occurrence of each of the first, second, and third targeted acquisition event involving the particular customer during the future temporal interval). For instance, and as illustrated in FIG. 2B, element 234 of output data 230 may include a linear array populated with these numerical values, e.g., linear array {0.78, 0.17, and 0.05}, which indicates a 78% probability that the particular customer will acquire a secondary checking account holding funds denominated in Canadian dollars within the future temporal interval (e.g., a one-month interval disposed between one and two months subsequent to the temporal prediction point), a 17% probability that the particular customer will acquire a secondary checking account holding funds denominated in U.S. dollars within the future temporal interval, and a 5% likelihood that the particular customer will fail to acquire a secondary checking in either U.S. or Canadian dollars during the future temporal interval.

In some instances, executed product management engine 242 may obtain element 238 of processed output data 236, based on element 234 of output data 230, executed product management engine 242 may establish the 78% predicted likelihood that the particular customer will acquire the secondary checking account holding funds denominated in Canadian dollars during the future temporal interval, and may obtain one or more elements of digital content 244 associated with the likely acquisition of the secondary checking account holding funds denominated in Canadian dollars from data repository 205 (e.g., as maintained within the one or more tangible, non-transitory memories of issuer system 203). The elements of digital content 244 may identify and characterize one or more targeted, customer-specific incentives the prompt the particular customer to acquire the secondary checking account holding funds denominated in Canadian dollars during the future temporal interval (e.g., an incentive to initiate a corresponding application process), and additionally, or alternatively, that facilitate an expected acquisition of the secondary checking account holding funds denominated in Canadian dollars during the future temporal interval.

Examples of the targeted, customer-specific incentives include, but are not limited to an incentive that provides a predetermined quantity of rewards points, or a redeemable cash reward to the particular customer of the financial institution, in exchange for exchange for initiating the application process for the secondary checking account. Further, in some examples, the elements of digital content 244 may include a deep link associated with a pre-populated portion of a corresponding digital interface of an application for the secondary checking account, or information that identifies those elements of physical or digital documentation associated with a completion of the application. Executed product management engine 242 may generate a notification that include the elements of digital content 244 (e.g., including the targeted, customer-specific incentives), which issuer system 203 may transmit across network 120 to an additional computing device operable by the additional customer. As described herein, an application program, such as the mobile banking application, executed by one or more processors of the additional computing device may process and present a graphical representation of all, or a selected portion of, the targeted, customer-specific incentives within a corresponding digital interface.

The disclosed embodiments are, however, not limited to, incentives and other elements of digital content targeting specific customers of the financial institution (e.g., associated with corresponding ones of the elements of processed output data 236). In other examples, executed product management engine 242 may access and process the elements of explainability data 184, including subsets 186, 188, and 190 that characterize a relative contribution of each of the discrete features specified within input data 182 to the predicted likelihood of the occurrences of respective ones of the first, second, and third targeted acquisition events by customers of the financial institution during the future temporal internal. For instance, executed product management engine 242 may process second subset 188 of the elements of explainability data 184, and identify one or more features associated with the largest relative contribution to the likelihood that a customer that maintains a primary account will acquire a secondary checking account holding funds denominated in U.S. currency during the future temporal interval (e.g., those features having relative contributions that exceed a predetermined threshold value). Based on the one or more identified features, executed product management engine 242 may generate one or more elements of promotional data 250 that identify and characterize certain characteristics of customers of the financial institution that predispose these customers to acquire secondary checking accounts holding funds denominated in U.S. currency. In some instances, the elements of promotional data 250 may establish al, or a portion, of a sales script that not only enables representatives of the financial institution to identify those customers disposed to acquire one or more of the secondary checking accounts described herein, but also to link the acquisition of these secondary checking accounts to transactional behaviors of these customers or interactions of these customers with physical or digital resources of the financial institution (e.g., automated teller machines, bank branches, mobile apps, etc.).

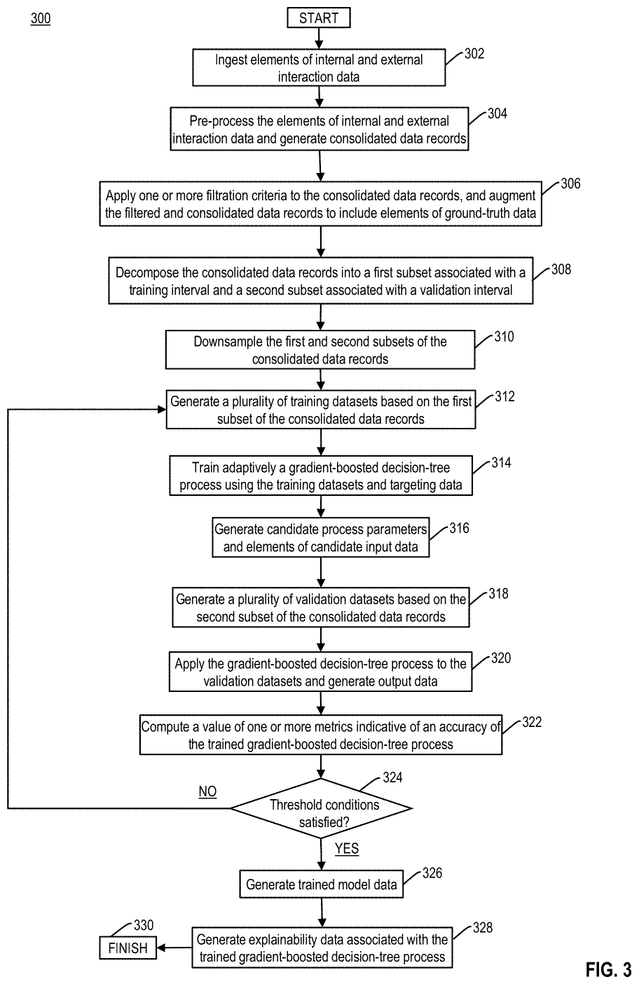

FIG. 3 is a flowchart of an exemplary process 300 for adaptively training a machine learning or artificial intelligence process to predict a likelihood of an occurrence of each of a plurality of predetermined, targeted acquisition events involving a customer of the financial institution during a future temporal interval using training data associated with a first prior temporal interval, and using validation data associated with a second, and distinct, prior temporal interval, in accordance with the disclosed exemplary embodiments. As described herein, the machine-learning or artificial-intelligence process may include an ensemble or decision-tree process, such as a gradient-boosted, decision-tree process (e.g., an XGBoost process), and the training and validation data may include, but are not limited to, elements of the profile, account, transaction, branch-access, and/or digital-access data characterizing corresponding ones of the customers of the financial institution.

By way of example, the customer of the financial institution may hold a checking account issued by the financial institution (e.g., a “primary” checking account) which may hold funds denominated a corresponding currency, such as Canadian or U.S. dollars, and the plurality of predetermined, targeted acquisition events may include, but are not limited to, a first targeted acquisition event associated with an acquisition, by the customer, of an additional checking account issued by the financial institution and (e.g., a “secondary” checking account) holding funds denominated in a first currency (e.g., Canadian dollars), a second targeted acquisition event associated with an acquisition, by the customer, of a secondary checking account issued by the financial institution and holdings funds denominated in a second currency (e.g., U.S. dollars), and a third targeted acquisition event associated with a failure of the customer to acquire a secondary checking account issued by the financial institution. In some instances, one or more computing systems, such as, but not limited to, one or more of the distributed components of FI computing system 130, may perform one or of the steps of exemplary process 300, as described herein.

Referring to FIG. 3, FI computing system 130 may perform any of the exemplary processes described herein to establish a secure, programmatic channel of communication with one or more source computing systems, such as source systems 110 of FIG. 1A, and to obtain, from the source computing systems, elements interaction data that identify and characterize one or more customers of the financial institution (e.g., in step 302 of FIG. 3). As described herein, the elements of interaction data may include, but are not limited to, one or more elements of customer profile, account, or transaction data associated with corresponding ones of the customers, elements of branch-access data that characterize the customers' interactions with bank branches of the financial institution, and elements of digital-access data that characterize the customers' interaction with one or more digital platforms of the financial institution (e.g., voice-based platforms, web-based platforms, or app-based platforms). FI computing system 130 may also perform operations that store (or ingest) the obtained elements of interaction within one or more accessible data repositories, such as aggregated data store 132 (e.g., also in step 302 of FIG. 3). In some instances, FI computing system 130 may perform the exemplary processes described herein to obtain and ingest the elements of elements of interaction data in accordance with a predetermined temporal schedule (e.g., on a monthly basis), or a continuous streaming basis, across the secure, programmatic channel of communication.

In some instances, FI computing system 130 may access the ingested elements of interaction data, and may perform any of the exemplary processes described herein to pre-process the ingested elements of internal and external interaction data elements (e.g., the elements of customer profile, account, transaction, branch-access, and/or digital-access data described herein) and generate one or more consolidated data records (e.g., in step 304 of FIG. 3). As described herein, the FI computing system 130 may store each of the consolidated data records within one or more accessible data repositories, such as consolidated data store 144 (e.g., also in step 304 of FIG. 3).

For example, and as described herein, each of the consolidated data records may be associated with a particular one of the customers, and may include a corresponding pair of a customer identifier associated with the particular customer (e.g., an alphanumeric character string, etc.) and a temporal interval that identifies a corresponding temporal interval. Further, and in addition to the corresponding pair of customer and temporal identifiers, each of the consolidated data records may also include one or more consolidated elements of customer profile, account, transaction, branch-access, and/or digital-access data that characterize the particular customer during the corresponding temporal interval associated with the temporal identifier.

FI computing system 130 may also perform any of the exemplary processes described herein to filter the consolidated data records in accordance with one or more filtration criteria, and to augment the filtered and consolidated data records include additional information characterizing a ground truth associated with a corresponding one of the customers and a corresponding temporal interval (e.g., in step 306 of FIG. 3). Further, FI computing system 130 may perform any of the exemplary processes described herein to decompose the filtered and consolidated data records into (i) a first subset of the consolidated data records having temporal identifiers associated with a first prior temporal interval (e.g., training interval Δt_{training}, as described herein) and (ii) a second subset of the consolidated data records having temporal identifiers associated with a second prior temporal interval (e.g., validation interval Δt_{validation}, as described herein), which may be separate, distinct, and disjoint from the first prior temporal interval (e.g., in step 308 of FIG. 3). By way of example, portions of the consolidated data records within the first subset may be appropriate to train adaptively the machine-leaning or artificial process (e.g., the gradient-boosted decision model described herein during training interval Δt_{training}, and portions of the consolidated records within the second subset may be appropriate to validating the adaptively trained gradient-boosted decision model during validation interval Δt_{validation}.

In some instances, the consolidated data records within first and second subsets may represent an imbalanced data set in which actual occurrences of the third targeted acquisition event involving customers of the financial institution during the target interval Δt_{target} outnumber disproportionately actual occurrences of the first and second targeted acquisition events involving the customers of the financial institution during the target interval Δt_{target}. Based on the imbalanced character of first and second subsets, FI computing system 130 may perform any of the exemplary processes described herein to downsample the consolidated data records within first and second subsets that are associated with the actual occurrences of the third targeted acquisition event (e.g., in step 310 of FIG. 3). By way of example, the downsampled data records within first and second subsets may maintain, for each of the customers of the financial institution, a predetermined maximum number of data records that characterize actual occurrences of the third targeted acquisition event associated with the failure to acquire the secondary checking account (e.g., two data records per customer, etc.). In some instances, the downsampled data records maintained within each first and second subsets may represent balanced data sets characterized by a more proportionate balance between the actual occurrences of the first, second, and third targeted acquisition events involving customers of the financial institution during the target interval Δt_{target}.

In some instances, FI computing system 130 may perform any of the exemplary processes described herein to generate a plurality of training datasets based on elements of data obtained, extracted, or derived from all or a selected portion of the first subset of the consolidated data records (e.g., in step 312 of FIG. 3). By way of example, each of the plurality of training datasets may be associated with a corresponding one of the customers of the financial institution and a corresponding temporal interval, and may include, among other things a customer identifier associated with that corresponding customer and a temporal identifier representative of the corresponding temporal interval, as described herein. Further, and as described herein, each of the plurality of training datasets may also include elements of data (e.g., feature values) that characterize the corresponding one of the customers, the corresponding customer's interaction with the financial institution or with other financial institutions, and/or the corresponding customer's interaction with the financial products issued by the financial institution or by other financial institutions during a temporal interval disposed prior to the corresponding temporal interval, e.g., prior extraction interval Δt_{extract} described herein.

Based on the plurality of training datasets, and on corresponding elements of ground-truth data, FI computing system 130 may also perform any of the exemplary processes described herein to train adaptively the machine-learning or artificial-intelligence process (e.g., the gradient-boosted decision-tree process described herein) to predict, during at a temporal prediction point a current temporal interval, a likelihood of an occurrence of each of the plurality of predetermined, targeted acquisition events involving a customer of the financial institution during a future temporal interval (e.g., in step 314 of FIG. 3). For example, and as described herein, FI computing system 130 may perform operations that establish a plurality of nodes and a plurality of decision trees for the gradient-boosted, decision-tree process, which may ingest and process the elements of training data (e.g., the customer identifiers, the temporal identifiers, the feature values, etc.) maintained within each of the plurality of training datasets, and that adaptively train the gradient-boosted, decision-tree process against the elements of training data included within each of the plurality of the training datasets and corresponding elements of the ground-truth data. For example, FI computing system 130 may perform any of the exemplary processes described herein (e.g., in step 314 of FIG. 3) to train adaptively the machine-learning or artificial-intelligence process in accordance with elements of targeting data that identify and characterize each of the plurality of targeted classes of acquisition events (e.g., the first, second, and third targeted acquisition events, as described herein), and a maintenance of discrete features, or discrete groups of features, within training datasets generated through these exemplary adaptive training processes may be guided by corresponding values of probabilistic metrics that average a computed area under curve for receiver operating characteristic (ROC) curves across corresponding pairs of the multiple targets or classes, such as, but limited to a value of a multiclass, one-versus-all area under curve (MAUC) a receiver operating characteristic (ROC) curve, as described herein.

In some examples, the distributed components of FI computing system 130 may perform any of the exemplary processes described herein in parallel to establish the plurality of nodes and a plurality of decision trees for the gradient-boosted, decision-tree process, and to adaptively train the gradient-boosted, decision-tree process against the elements of training data included within each of the plurality of the training datasets. The parallel implementation of these exemplary adaptive training processes by the distributed components of FI computing system 130 may, in some instances, be based on an implementation, across the distributed components, of one or more of the parallelized, fault-tolerant distributed computing and analytical protocols described herein.

Through the performance of these adaptive training processes, FI computing system 130 may compute one or more candidate process parameters that characterize the adaptively trained machine-learning or artificial-intelligence process, such as, but not limited to, candidate process parameters for the adaptively trained, gradient-boosted, decision-tree process described herein (e.g., in step 316 of FIG. 3). In some instances, and for the adaptively trained, gradient-boosted, decision-tree process, the candidate process parameters included within candidate process data may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, and based on the performance of these adaptive training processes, FI computing system 130 may perform any of the exemplary processes described herein to generate candidate input data, which specifies a candidate composition of an input dataset for the adaptively trained machine-learning or artificial intelligence process, such as the adaptively trained, gradient-boosted, decision-tree process (e.g., also in step 316 of FIG. 3).

Further, FI computing system 130 may perform any of the exemplary processes described herein to access the second subset of the consolidated data records, and to generate a plurality of validation subsets having compositions consistent with the candidate input data and corresponding elements of ground-truth data (e.g., in step 318 of FIG. 3). As described herein, each of the plurality of the validation datasets may be associated with a corresponding one of the customers of the financial institution, and with a corresponding temporal interval within validation interval Δt_{validation}, and may include a customer identifier associated with the corresponding one of the customers and a temporal identifier that identifies the corresponding temporal interval. Further, each of the plurality of the validation datasets may also include one or more feature values that are consistent with the candidate input data, associated with the corresponding one of the customers, and obtained, extracted, or derived from corresponding ones of the accessed second subset of the consolidated data records (e.g., during extraction interval Δt_{extract}, as described herein).

In some instances, FI computing system 130 may perform any of the exemplary processes described herein to apply the adaptively trained machine-learning or artificial intelligence process (e.g., the adaptively trained, gradient-boosted, decision-tree process described herein) to respective ones of the validation datasets, and to generate corresponding elements of output data based on the application of the adaptively trained machine-learning or artificial intelligence process to the respective ones of the validation datasets (e.g., in step 320 of FIG. 3). As described herein, each of the generated elements of output data may be associated with a respective one of the validation datasets and as such, a corresponding one of the customers of the financial institution. Further, each of the generated elements of output data may also include a numerical value indicative of a predicted likelihood of the occurrence of each of the plurality of targeted acquisition events (e.g., the first, second, and third targeted acquisition events, as described herein) involving the corresponding one of the customers during the future temporal interval. In some examples, each of the numerical values may range from zero to unity, and the numerical values characterizing the predicted likelihoods of the occurrences of the first, second, and third targeted acquisition events involving the corresponding one of the customers during the future temporal interval may sum to unity.

As described herein, the distributed components of FI computing system 130 may perform any of the exemplary processes described herein in parallel to validate the adaptively trained, gradient-boosted, decision-tree process described herein based on the application of the adaptively trained, gradient-boosted, decision-tree process (e.g., configured in accordance with the candidate process parameters) to each of the validation datasets. The parallel implementation of these exemplary adaptive validation processes by the distributed components of FI computing system 130 may, in some instances, be based on an implementation, across the distributed components, of one or more of the parallelized, fault-tolerant distributed computing and analytical protocols described herein.

In some examples, FI computing system 130 may perform any of the exemplary processes described herein to compute a value of one or more metrics that characterize a predictive capability, and an accuracy, of the adaptively trained machine-learning or artificial intelligence process (such as the adaptively trained, gradient-boosted, decision-tree process described herein) based on the generated elements of output data and corresponding ones of the validation datasets (e.g., in step 322 of FIG. 3), and to determine whether all, or a selected portion of, the computed metric values satisfy one or more threshold conditions for a deployment of the adaptively trained machine-learning or artificial intelligence process (e.g., in step 324 of FIG. 3). As described herein, and for the adaptively trained, gradient-boosted, decision-tree process, the computed metrics may include, but are not limited to, one or more recall-based values (e.g., “recall@5,” “recall@10,” “recall@20,” etc.), one or more precision-based values for the adaptively trained, gradient-boosted, decision-tree process, and additionally, or alternatively, a computed value of an area under curve (AUC) for a precision-recall (PR) curve, a computed value of an AUC for a receiver operating characteristic (ROC) curve associated with the adaptively trained, gradient-boosted, decision-tree process, and/or a multiclass, over-versus-all area under curve (MAUC) for a receiver operating characteristic (ROC) curve.

Further, and as described herein, the threshold requirements for the adaptively trained, gradient-boosted, decision-tree process may specify one or more predetermined threshold values, such as, but not limited to, a predetermined threshold value for the computed recall-based values, a predetermined threshold value for the computed precision-based values, and/or a predetermined threshold value for the computed AUC or MAUC values. In some examples, FI computing system 130 may perform any of the exemplary processes described herein to establish whether one, or more, of the computed recall-based values, the computed precision-based values, or the computed AUC or MAUC values exceed, or fall below, a corresponding one of the predetermined threshold values and as such, whether the adaptively trained, gradient-boosted, decision-tree process satisfies the one or more threshold requirements for deployment.

If, for example, FI computing system 130 were to establish that one, or more, of the computed metric values fail to satisfy at least one of the threshold requirements (e.g., step 324; NO), FI computing system 130 may establish that the adaptively trained machine-learning or artificial-intelligence process (e.g., the adaptively trained, gradient-boosted, decision-tree process) is insufficiently accurate for deployment and a real-time application to the elements of customer profile, account, transaction, branch-access, and/or digital-access data described herein. Exemplary process 300 may, for example, pass back to step 314, and FI computing system 130 may perform any of the exemplary processes described herein to generate additional training datasets based on the elements of the consolidated data records maintained within the first subset.

Alternatively, if FI computing system 130 were to establish that each computed metric value satisfies threshold requirements (e.g., step 324; YES), FI computing system 130 may deem the machine-learning or artificial intelligence process (e.g., the gradient-boosted, decision-tree process described herein) adaptively trained and ready for deployment and real-time application to the elements of customer profile, account, transaction, credit-bureau, branch-access, and/or digital-access data described herein, and may perform any of the exemplary processes described herein to generate trained process data that includes the candidate process parameters and candidate input data associated with the of the adaptively trained machine-learning or artificial intelligence process (e.g., in step 326 of FIG. 3). Further, in some instances, FI computing system 130 may also perform any of the exemplary processes described herein to, based on a predetermined subset of a parameter space associated with one or more of the process parameters of the adaptively trained, gradient-boosted, decision-tree process, implement a programmatic grid search or parameter sweep that optimizes a value of the one or more of the process parameters, as determined herein (e.g., also in step 326 of FIG. 3).

In some instances, FI computing system 130 may also perform any of the exemplary processes described herein to generate one or more elements of explainability data 184 that, among other things, characterize a contribution of each of the discrete explainability features specified within the now-validated input data to the predicted likelihood of the occurrence of the first targeted acquisition event, the second targeted acquisition event, and/or the third targeted acquisition event involving customers of the financial institution during the future temporal interval (e.g., in step 328 of FIG. 3). As described herein, FI computing system 130 may perform operations that compute the relative contribution and importance of each of the discrete features to the predicted likelihoods of the occurrences of respective ones of the first, second, and third targeted acquisition events based on a determined number of branching points that utilize the corresponding feature, based on a computed Shapley feature value for the corresponding feature, or based on any additional or alternate, metric indicative of the contribution of the corresponding feature to the predicted likelihoods of the occurrences of respective ones of the first, second, and third targeted acquisition events. FI computing system 130 may also store the elements of explainability data within the one or more tangible, non-transitory memories of FI computing system 130, such as consolidated data store 144 (e.g., also in step 328 of FIG. 3). Exemplary process 300 is then complete in step 330.

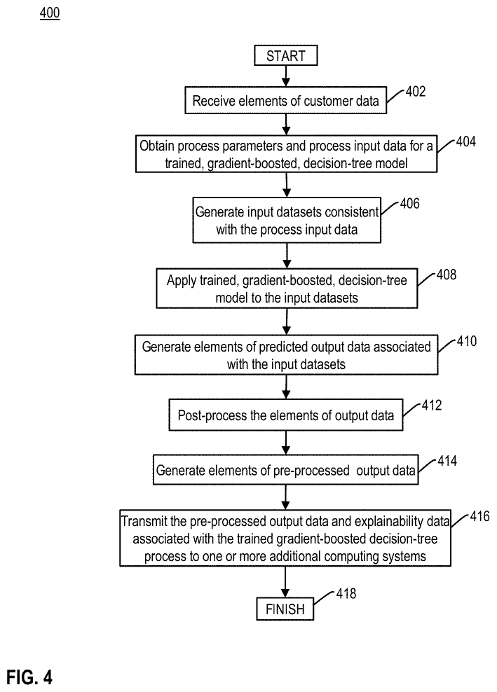

FIG. 4 is a flowchart of an exemplary process 400 for predicting a likelihood of an occurrence of each of a plurality of predetermined, targeted acquisition events involving a customer of the financial institution during a future temporal interval using adaptively trained machine-learning or artificial-intelligence processes, in accordance with the disclosed exemplary embodiments. As described herein, the machine-learning or artificial-intelligence processes may include an ensemble or decision-tree process, such as a gradient-boosted decision-tree process (e.g., the XGBoost model), which may be trained adaptively to predict an expected occurrence of one of a plurality of targeted classes of acquisition events involving a customer of the financial institution during a future temporal interval using training datasets associated with a first prior temporal interval (e.g., training interval Δt_{training}, as described herein), and using validation datasets associated with a second, and distinct, prior temporal interval (e.g., validation interval Δt_{validation}, as described herein).

By way of example, the customer of the financial institution may hold a checking account issued by the financial institution (e.g., a “primary” checking account) which may hold funds denominated a corresponding currency, such as Canadian or U.S. dollars, and the plurality of predetermined, targeted acquisition events may include, but are not limited to, a first targeted acquisition event associated with an acquisition, by the customer, of an additional checking account issued by the financial institution and (e.g., a “secondary” checking account) holding funds denominated in a first currency (e.g., Canadian dollars), a second targeted acquisition event associated with an acquisition, by the customer, of a secondary checking account issued by the financial institution and holdings funds denominated in a second currency (e.g., U.S. dollars), and a third targeted acquisition event associated with a failure of the customer to acquire a secondary checking account issued by the financial institution. The future temporal interval may, for example, correspond to a one-month interval disposed between one and two months subsequent to a temporal prediction point during a current temporal interval, and in some instances, one or more computing systems, such as, but not limited to, one or more of the distributed components of FI computing system 130, may perform one or more of the steps of exemplary process 400, as described herein.

Referring to FIG. 4, FI computing system 130 may perform any of the exemplary processes described herein to receive elements of customer data that identify one or more customers of the financial institution (e.g., in step 402 of FIG. 4). For example, FI computing system 130 may receive the elements of customer data from one or more additional computing systems associated with, or operated by, the financial institution (such as, but not limited to, one or more of issuer systems 201, including issuer system 203), and in some instances, FI computing system 130 may perform any of the exemplary processes described herein to store the obtained elements of customer data within a locally accessible data repository (e.g., within aggregated data store 132). As described herein, each of the customer associated with, and characterized by, the elements of customer data may hold a primary checking account issued by the financial institution. Further, in some instances, FI computing system 130 may also perform any of the exemplary processes described herein to synchronize and merge the obtained elements of customer data with one or more previously ingested elements of customer data maintained within the locally accessible data repository. As described herein, each of the elements of customer data may be associated with a corresponding one of the customers, and may include a customer identifier associated with the corresponding one of the customers (e.g., the alphanumeric character string, etc.) and a system identifier associated with a corresponding one of the additional computing systems (e.g., an IP or MAC address of issuer system 203, etc.).

FI computing system 130 may perform any of the exemplary processes described herein to generate an input dataset associated with each of the customers identified by the discrete elements of customer data 202, and to apply the adaptively trained, gradient-boosted, decision-tree process described herein to each of the input datasets, in accordance with a predetermined temporal schedule (e.g., on a monthly basis), or in response to a detection of a triggering event. By way of example, and without limitation, the triggering event may correspond to a detected change in a composition of the elements of customer data 202 maintained within aggregated data store (e.g., to an ingestion of additional elements of customer data 202, etc.) or to a receipt of an explicit request received from one or more of issuer systems 201.

For example, FI computing system 130 may also perform any of the exemplary processes described herein to obtain one or more process parameters that characterize the adaptively trained machine-learning or artificial-intelligence process (e.g., the adaptively trained, gradient-boosted, decision-tree process described herein) and elements of process input data that specify a composition of an input dataset for the adaptively trained machine-learning or artificial-intelligence process (e.g., in step 404 of FIG. 4). In some instances, and for the adaptively trained, gradient-boosted, decision-tree process described herein, the one or more process parameters may include, but are not limited to, a learning rate associated with the adaptively trained, gradient-boosted, decision-tree process, a number of discrete decision trees included within the adaptively trained, gradient-boosted, decision-tree process (e.g., the “n_estimator” for the adaptively trained, gradient-boosted, decision-tree process), a tree depth characterizing a depth of each of the discrete decision trees included within the adaptively trained, gradient-boosted, decision-tree process, a minimum number of observations in terminal nodes of the decision trees, and/or values of one or more hyperparameters that reduce potential model overfitting (e.g., regularization of pseudo-regularization hyperparameters). Further, the elements of model input data may specify the composition of the input dataset for the adaptively trained, gradient-boosted, decision-tree process, which not only identifies the elements of customer-specific data included within each input dataset (e.g., input feature values, as described herein), but also a specified sequence or position of these input feature values within the input dataset.

In some instances, FI computing system 130 may access the elements of customer data associated with one or more customers of the financial institution, and may perform any of the exemplary processes described herein to generate, for the one or more customers, an input dataset having a composition consistent with the elements of model input data (e.g., in step 406 of FIG. 4). By way of example, and as described herein, the elements of customer data may include customer identifiers associated with each of the customers of the financial institution, or with a selected subset of these customers (e.g., those customers that hold an unsecured credit product issued by the financial institution), and FI computing system 130 may generate the input datasets for each of these customers in accordance with a predetermined schedule (e.g., on a monthly basis) or based on a detected occurrence of a triggering event. In other examples, one or more of the elements of customer data may be associated with a customer-specific request for an unsecured credit product (e.g., received at issuer system 203 from a device operable by a corresponding one of the customers), and FI computing system 130 may perform operations that generate the input dataset for that corresponding customer in real-time and contemporaneously with the receipt of the one or more elements of the customer data from issuer system 203.

Further, and based on the one or more obtained process parameters, FI computing system 130 may perform any of the exemplary processes described herein to apply the adaptively trained machine-learning or artificial-intelligence process (e.g., the adaptively trained, gradient-boosted, decision-tree process described herein) to each of the generated, customer-specific input datasets (e.g., in step 408 of FIG. 4), and to generate a customer-specific element of predicted output data associated with each of the customer-specific input datasets (e.g., in step 410 of FIG. 4). For example, and based on the one or more obtained process parameters, FI computing system 130 may perform operations, described herein, that establish a plurality of nodes and a plurality of decision trees for the adaptively trained, gradient-boosted, decision-tree process, each of which receive, as inputs (e.g., “ingest”), corresponding elements of the customer-specific input datasets. Based on the ingestion of the input datasets by the established nodes and decision trees of the adaptively trained, gradient-boosted, decision-tree process, FI computing system 130 may perform operations that apply the adaptively trained, gradient-boosted, decision-tree process to each of the customer-specific input datasets and that generate the customer-specific elements of the output data associated with the customer-specific input datasets.

As described herein, each of the customer-specific elements of the output data may include a numerical value indicative of the predicted likelihood of the occurrence of each of the plurality of predetermined, targeted acquisition events (e.g., the first targeted acquisition event, the second targeted acquisition event, or the third targeted acquisition event specified within targeting data 167) involving a corresponding one of the customers during the future temporal interval (e.g., target interval Δt_{target}. In some examples, each of the numerical values may range from zero to unity, and the numerical values characterizing the predicted likelihoods of the occurrences of the first, second, and third targeted acquisition events involving the corresponding one of the customer during the future temporal interval may sum to unity. Further, and as described herein, the future temporal interval may include, but is not limited to, a one-month period disposed between one and two months subsequent to a corresponding prediction date (e.g., the prediction date t_{pred} described herein).

In step 412 of FIG. 4, FI computing system 130 may also perform any of the exemplary processes described herein to pre-process the customer-specific elements of output data and, among other things, associated each of the customer-specific elements of output data with a corresponding one of the customer identifiers and in some instances, with a corresponding one of the system identifiers, e.g., as maintained within the elements of customer data). Further, FI computing system 130 may also perform any of the exemplary processes described herein to generate elements of pre-processed output data that include the associated elements of customer data and the elements of customer-specific output data (e.g., in step 414 of FIG. 4).

Further, and based on the corresponding system identifier, FI computing system 130 may perform any of the exemplary processes described herein to transmit all, or a selected portion of, the elements of pre-processed output data, along with one or more elements of explainability data associated with the adaptively trained machine-learning or artificial-intelligence process, to a corresponding one of the additional computing systems associated with the financial institution, which include, but are not limited to, a corresponding one of issuer systems 201, such as issuer system 203 (e.g., in step 416 of FIG. 4). As described herein, one or more of issuer systems 201, such as issuer system 203, may receive a corresponding portion of the elements of pre-processed output data, and the one or more elements of explainability data, from FI computing system 130.

In some instances, the one or more of issuer systems 201, such as issuer system 203, may perform any of the exemplary processes described herein to that parse each the elements of pre-processed output data and obtain the numerical values that characterize the predicted likelihood of each of the first targeted acquisition event (e.g., the acquisition of the secondary checking account holding funds denominated in the first currency, such as Canadian dollars), the second targeted acquisition event (e.g., the acquisition of the secondary checking account holding funds denominated in the second currency, such as U.S. dollars), and the third targeted acquisition event (e.g., the failure to acquire the secondary checking account) associated with a corresponding customer during the future temporal interval. Based on the numerical values, and on the predicted likelihoods, the one or more of issuer systems 201, such as issuer system 203, may perform any of the exemplary processes described herein to obtain one or more elements of elements of digital content that identify, or characterize, targeted, customer-specific incentives the prompt the particular customer to acquire one or more of the secondary checking accounts described herein during the future temporal interval (e.g., an incentive to initiate a corresponding application process), and additionally, or alternatively, that facilitate an expected acquisition of the secondary checking account holding funds denominated in Canadian dollars during the future temporal interval.

Further, in some examples, and based on the elements of explainability data, the one or more of issuer systems 201, such as issuer system 203, may perform any of the exemplary processes described herein to identify one or more features associated with the largest relative contribution to the likelihood that a customer that maintains a primary account will acquire a secondary checking account holding funds denominated in Canadian currency or U.S. currency during the future temporal interval, e.g., those features having relative contributions that exceed a predetermined threshold value. Based on these identified features, the one or more of issuer systems 201, such as issuer system 203, may perform any of the exemplary processes described herein to generate elements of promotional data that identify and characterize certain characteristics of customers of the financial institution that predispose these customers to acquire secondary checking accounts holding funds denominated in Canadian or U.S. currency. As described herein, the elements of promotional data may establish all, or a portion, of a sales script that not only enables representatives of the financial institution to identify those customers disposed to acquire one or more of the secondary checking accounts described herein, but also to link the acquisition of these secondary checking accounts to transactional behaviors of these customers or interactions of these customers with physical or digital resources of the financial institution (e.g., automated teller machines, bank branches, mobile apps, etc.). Exemplary process 400 is then completed in step 418.

### C. Exemplary Hardware and Software Implementations

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, including, but not limited to, application programming interfaces (APIs) 134, 204, and 237, data ingestion engine 136, pre-processing engine 140, training engine 162, training input module 166, adaptive training and validation module 172, process input engine 212, predictive engine 228, post-processing engine 232, and product management engine 242, can be implemented as one or more computer programs, i.e., one or more modules of computer program instructions encoded on a tangible non transitory program carrier for execution by, or to control the operation of, a data processing apparatus (or a computer system).

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

What is claimed is:

1. An apparatus, comprising:
a memory storing instructions;
a communications interface; and
at least one processor coupled to the memory and the communications interface, the at least one processor being configured to execute the instructions to:
generate an input dataset based on elements of first interaction data associated with a first temporal interval;
based on an application of a trained artificial intelligence process to the input dataset, generate output data indicative of a predicted likelihood of an occurrence of each of a plurality of targeted events during a second temporal interval, the second temporal interval being subsequent to the first temporal interval and being separated from the first temporal interval by a corresponding buffer interval; and
transmit the output data to a computing system via the communications interface, the computing system being configured to transmit digital content to a device based on at least a portion of the output data.

2. The apparatus of claim 1, wherein the at least one processor is further configured to execute the instructions to:
receive at least a portion of the first interaction data from the computing system via the communications interface; and
store the portion of the first interaction data within the memory.

3. The apparatus of claim 1, wherein the at least one processor is further configured to execute the instructions to:
obtain (i) one or more parameters that characterize the trained artificial intelligence process and (ii) data that characterizes a composition of the input dataset;
generate the input dataset in accordance with the data that characterizes the composition; and
apply the trained artificial intelligence process to the input dataset in accordance with the one or more parameters.

4. The apparatus of claim 3, wherein the at least one processor is further configured to execute the instructions to:
based on the data that characterizes the composition, perform operations that at least one of extract a first feature value from the first interaction data or compute a second feature value based on the first feature value; and
generate the input dataset based on at least one of the first feature value or the second feature value.

5. The apparatus of claim 1, wherein the trained artificial intelligence process comprises a trained, gradient-boosted, decision-tree process.

6. The apparatus of claim 1, wherein:
the plurality of targeted events comprise a first targeted acquisition event, a targeted second acquisition event, and a third targeted acquisition event; and
the output data comprises a plurality of numerical values, each of the numerical values being indicative of the predicted likelihood of the occurrence of each of a corresponding one of the first, second, and third targeted acquisition events during the second temporal interval.

7. The apparatus of claim 6, wherein:
the first interaction data is associated with a customer, and the customer is associated with a primary product; and
the first targeted acquisition event corresponds to an acquisition of a secondary product by the customer, the second targeted acquisition event corresponds to an acquisition of an additional secondary product by the customer, and the third targeted acquisition event corresponds to a failure of the customer to acquire the secondary product or the additional secondary product.

8. The apparatus of claim 6, wherein:
the first interaction data comprises a customer identifier associated with the customer and a temporal identifier associated with the first temporal interval; and
the at least one processor is further configured to execute the instructions to:
receive the customer identifier from the computing system via the communications interface; and
obtain the elements of the first interaction data from a portion of the memory based on the received customer identifier.

9. The apparatus of claim 1, wherein:
the first interaction data is associated with a plurality of customers; and
the at least one processor is further configured to execute the instructions to:
generate a plurality of input datasets based on the first interaction data, each of the plurality of input datasets being associated with a corresponding one of the customers;
apply the trained artificial intelligence process to each of the plurality of input datasets, and generate elements of the output data based on the application of the trained artificial intelligence to each of the plurality of input datasets, each of the elements of output data being associated with the corresponding one of the customers, and each of the elements of output data indicating, for the corresponding one of the customers, the predicted likelihood of the occurrence of each of the plurality of targeted events during the second temporal interval; and
transmit at least a subset of the elements of output data to the computing system via the communications interface.

10. The apparatus of claim 1, wherein:
the input dataset comprises value of a plurality of input features; and
the at least one processor is further configured to execute the instructions to:
obtain explainability data associated with the trained artificial intelligence process, the explainability data characterizing a contribution of at least one of the input features to the predicted likelihood of the occurrence of at least one of the plurality of targeted events during the second temporal interval; and
transmit the output data and at least a portion of the explainability data to the computing system via the communications interface.

11. The apparatus of claim 1, wherein the at least one processor is further configured to execute the instructions to:
obtain elements of second interaction data and elements of targeting data, each of the elements of the second interaction data comprising a temporal identifier associated with a temporal interval, and the elements of targeting data identifying the targeted events;
based on the temporal identifiers, determine that a first subset of the elements of the second interaction data are associated with a prior training interval, and that a second subset of the elements of the second interaction data are associated with a prior validation interval; and
generate a plurality of training datasets based corresponding portions of the first subset, and perform operations that train the artificial intelligence process based on the training datasets and on the targeting data.

12. The apparatus of claim 11, wherein the at least one processor is further configured to execute the instructions to:
generate a plurality of the validation datasets based on portions of the second subset;
apply the trained artificial intelligence process to the plurality of validation datasets, and generate additional elements of output data based on the application of the trained artificial intelligence process to the plurality of validation datasets;
compute one or more validation metrics based on the additional elements of output data; and
based on a determined consistency between the one or more validation metrics and a threshold condition, validate the trained artificial intelligence process.

13. A computer-implemented method, comprising:
generating, using at least one processor, an input dataset based on elements of first interaction data associated with a first temporal interval;
based on an application of a trained artificial intelligence process to the input dataset, generating, using the at least one processor, output data indicative of a predicted likelihood of an occurrence of each of a plurality of targeted events during a second temporal interval, the second temporal interval being subsequent to the first temporal interval and being separated from the first temporal interval by a corresponding buffer interval; and
transmitting the output data to a computing system using the at least one processor, the computing system being configured to transmit digital content to a device based on at least a portion of the output data.

14. The computer-implemented method of claim 13, wherein:
the trained artificial intelligence process comprises a trained, gradient-boosted, decision-tree process; and
the computer-implemented method further comprises:
using the at least one processor, obtaining (i) one or more parameters that characterize the trained artificial intelligence process and (ii) data that characterizes a composition of the input dataset;
based on the data that characterizes the composition, performing operations, using the at least one processor, that at least one of extract a first feature value from the first interaction data or compute a second feature value based on the first feature value; and
generating, using the at least one processor, the input dataset based on at least one of the first feature value or the second feature value, and in accordance with the data that characterizes the composition; and
applying, using the at least one processor, the trained artificial intelligence process to the input dataset in accordance with the one or more parameters.

15. The computer-implemented method of claim 13, wherein:
the plurality of targeted events comprise a first targeted acquisition event, a targeted second acquisition event, and a third targeted acquisition event; and
the output data comprises a plurality of numerical values, each of the numerical values being indicative of the predicted likelihood of the occurrence of each of a corresponding one of the first, second, and third targeted acquisition events during the second temporal interval.

16. The computer-implemented method of claim 15, wherein:
the first interaction data is associated with a customer, and the customer is associated with a primary product; and
the first targeted acquisition event corresponds to an acquisition of a secondary product by the customer, the second targeted acquisition event corresponds to an acquisition of an additional secondary product by the customer, and the third targeted acquisition event corresponds to a failure of the customer to acquire the secondary product or the additional secondary product.

17. The computer-implemented method of claim 13, wherein:
the input dataset comprises value of a plurality of input features; and
the computer-implemented method further comprises obtaining, using the at least one processor, explainability data associated with the trained artificial intelligence process, the explainability data characterizing a contribution of at least one of the input features to the predicted likelihood of the occurrence of at least one of the plurality of targeted events during the second temporal interval; and
the transmitting comprises transmitting the output data and at least a portion of the explainability data to the computing system.

18. The computer-implemented method of claim 13, further comprising:
obtaining, using the at least one processor, elements of second interaction data and elements of targeting data, each of the elements of the second interaction data comprising a temporal identifier associated with a temporal interval, and the elements of targeting data identifying the targeted events;
based on the temporal identifiers, determining, using the at least one processor, that a first subset of the elements of the second interaction data are associated with a prior training interval, and that a second subset of the elements of the second interaction data are associated with a prior validation interval; and
generating, using the at least one processor, a plurality of training datasets based corresponding portions of the first subset, and perform operations that train the artificial intelligence process based on the training datasets and on the targeting data.

19. The computer-implemented method of claim 18, further comprising:
generating, using the at least one processor, a plurality of the validation datasets based on portions of the second subset;
using the at least one processor, applying the trained artificial intelligence process to the plurality of validation datasets, and generating additional elements of output data based on the application of the trained artificial intelligence process to the plurality of validation datasets;
computing, using the at least one processor, one or more validation metrics based on the additional elements of output data; and
based on a determined consistency between the one or more validation metrics and a threshold condition, validating, using the at least one processor, the trained artificial intelligence process.

20. A tangible, non-transitory computer-readable medium storing instructions that, when executed by at least one processor, cause the at least one processor to perform a method, comprising:
generating an input dataset based on elements of first interaction data associated with a first temporal interval;
based on an application of a trained artificial intelligence process to the input dataset, generating output data indicative of a predicted likelihood of an occurrence of each of a plurality of targeted events during a second temporal interval, the second temporal interval being subsequent to the first temporal interval and being separated from the first temporal interval by a corresponding buffer interval; and
transmitting the output data to a computing system, the computing system being configured to transmit digital content to a device based on at least a portion of the output data.
